(19) United States
(12) Patent Application Publication
(10) Pub. No.: US 2009/0033936 A1
(43) Pub. Date: Feb. 5, 2009

(54) Optical characteristic measuring apparatus and optical characteristic measuring method

(75) Inventors: Yukitoshi Otani, Tokyo (JP); Toshitaka Wakayama, Tokyo (JP)

Correspondence Address: Reed Smith;3110 Fairview Park Drive, Suite 1400, Falls Church, VA, 22042, US

(73) Assignee: NATIONAL UNIVERSITY CORPORATION TOKYO UNIVERSITY AGRICULTURE AND TECHNOLOGY

(21) Appl. No.: 11/922,006

(22) PCT Filed: Jun. 9, 2006
(86) PCT No.: PCT/JP2006/311615

§ 371 Date: Feb. 6, 2008

(30) Foreign Application Priority Data
Jun. 13, 2005 (JP) 2005-172848

(51) Int. Cl. G01N 21/21

(52) U.S. Cl. 356/364

(57) ABSTRACT

An optical characteristic measuring apparatus including a carrier retarder of which the retardation is known and a quarter-wave plate without wavelength dependence, wherein light emitted from a light source (light-emitting device) is incident on a measurement target through a first polarizer (polarizer), the carrier retarder, and the quarter-wave plate, and the light which has passed through the measurement target is incident on a photodetector through a second polarizer (analyzer). A spectral peak is extracted from a frequency spectrum obtained by analyzing a light intensity signal detected by the photodetector. The optical characteristic element of the measurement target is calculated based on the extracted spectral peak and the retardation of the carrier retarder.

### TECHNICAL FIELD

The present invention relates to an optical characteristic measuring apparatus and an optical characteristic measuring method for measuring the optical characteristics of a measurement target.

### BACKGROUND ART

In recent years, a polarimeter (optical characteristic measuring apparatus in a broad sense) has been utilized for management of the sugar concentration in food, drinking water, and the like and examination of medical products.

An optical rotation measuring method, which was proposed long ago, is represented by a rotating polarizer method, a rotating analyzer method, and the like. In these methods, the slope of the polarization plane which occurs when linearly polarized light passes through a substance having optical activity is measured by moving the angle of rotation of an analyzer or a polarizer to an extinct position.

As a measuring method which does not mechanically drive a polarizer or an analyzer, a method using a Faraday cell, a liquid crystal, an acousto-optic element, a photoelastic modulator (PEM), or the like has been proposed (see JP-A-2004-198286). For example, the method using a Faraday cell electrically modulates incident polarized light utilizing a Faraday effect (i.e., a phenomenon in which the polarization plane of linearly polarized light is rotated by causing a current to flow through a coil wound around a glass rod) to measure the angle of rotation (see JP-A-9-145605).

### DISCLOSURE OF THE INVENTION

Most of the above-mentioned measuring methods utilize monochromatic light. On the other hand, the angle of rotation shows wavelength dependence in the same manner as the dispersion of a refractive index. This phenomenon is called optical rotatory dispersion. Since the optical rotatory dispersion has wavelength characteristics specific to a substance, the optical rotatory dispersion is important for characteristic analysis and structural analysis.

A crystal such as a crystal sugar is considered to exhibit birefringence due to stress which occurs upon solidification. An optical crystal such as a rock crystal may cause optical rotation and birefringence at the same time. It is also very important to separate and simultaneously measure the optical rotatory dispersion and the birefringence dispersion of such a substance.

However, when measuring the wavelength dependence of the angle of rotation and birefringence by applying a related-art measuring method, the optical element and the phase shift of the measurement system must be electrically or mechanically set in wavelength units. This makes it difficult to measure the wavelength dependence of the angle of rotation and birefringence within a short period of time.

The invention has been achieved in view of the above-described situation. An object of the invention is to provide an optical characteristic measuring apparatus and an optical characteristic measuring method capable of measuring the optical characteristics of a measurement target in a predetermined wavelength region.

(1) An optical characteristic measuring apparatus according to the invention is an optical characteristic measuring apparatus measuring optical characteristics of a measurement target, the optical characteristic measuring apparatus comprising:

an optical system including first and second carrier retarders of which the retardations are known and differ from each other and first and second quarter-wave plates without wavelength dependence, the optical system causing light emitted from a light source to be incident on the measurement target through a first polarizer, the first carrier retarder, and the quarter-wave plate and modulated by the measurement target, and causing the modulated light to be incident on light-receiving means through the second quarter-wave plate, the second carrier retarder, and a second polarizer; and

calculation means for performing a spectrum extraction process of extracting a spectral peak from a frequency spectrum obtained by analyzing a light intensity signal detected by the light-receiving means, and an optical characteristic element calculation process of calculating an optical characteristic element representing the optical characteristics of the measurement target based on the extracted spectral peak and the retardations of the first and second carrier retarders.

According to the invention, a configuration is employed in which light emitted from the light source is modulated by the optical elements and the measurement target utilizing the optical system formed by combining the first and second carrier retarders of which the retardations are known and differ from each other, the first and second quarter-wave plates without wavelength dependence, and the first and second polarizers.

According to this optical system, light modulated due to the effects of the first and second carrier retarders and the optical characteristics of the measurement target is incident on the light-receiving means. Therefore, when analyzing (e.g. Fourier analysis) the light intensity signal of the measurement light, the resulting frequency spectrum contains spectral peaks reflecting the principal axis directions and the retardations of the first and second carrier retarders and the optical characteristics of the measurement target.

Since the retardations of the first and second carrier retarders are known in advance, the optical characteristic element of the measurement target can be calculated by substituting the value read from the spectral peak extracted from the frequency spectrum and the retardations of the first and second carrier retarders in a theoretical equation (Fourier analysis theoretical equation) including a variable indicating the optical characteristic element of the measurement target.

The term “optical characteristic element” used herein refers to various elements (physical quantities) representing the optical characteristics of the measurement target. Examples of the optical characteristic element include the angle of rotation, the principal axis direction, and the retardation, each matrix element of a matrix (e.g. Mueller matrix) representing the optical characteristics, dichroism, and the like of the measurement target. Specifically, the measuring apparatus according to the invention can measure one or more of these optical characteristic elements. The measuring apparatus according to the invention can measure the optical characteristics of the measurement target by calculating the optical characteristic elements.

In the invention, the frequency spectrum is obtained by analyzing the light intensity signal detected by the light-receiving means. Specifically, the invention requires obtaining a light intensity signal from which a frequency spectrum can be obtained by analysis.

Therefore, the optical characteristic measuring apparatus according to the invention may be configured to utilize a light source (white light source) which emits light containing a predetermined band component.

The optical characteristic measuring apparatus according to the invention may be configured as a measuring apparatus (optical characteristic measuring apparatus) in which Fourier analysis is applied to the analysis process and which measures at least one of the optical activity, the birefringence, and the principal axis direction of the measurement target having optical transparency.

In this case, the optical characteristic measuring apparatus may be configured as a measuring apparatus which measures at least one of the optical activity, the birefringence, and the principal axis direction of a measurement target having optical transparency, the optical characteristic measuring apparatus comprising:

an optical system including first and second carrier retarders of which the retardations are known and differ from each other and first and second quarter-wave plates without wavelength dependence, the optical system causing light containing a predetermined band component to be incident on the measurement target through a first polarizer, the first carrier retarder, and the quarter-wave plate, and causing the light which has passed through the measurement target to be incident on light-receiving means through the second quarter-wave plate, the second carrier retarder, and a second polarizer; and

calculation means for performing a spectrum extraction process of extracting a plurality of (two) spectral peaks from a Fourier spectrum obtained by subjecting a light intensity signal detected by the light-receiving means to Fourier analysis, and a characteristic calculation process of calculating at least one of the optical activity, the birefringence, and the principal axis direction of the measurement target for the predetermined band component based on a plurality of the (two) extracted spectral peaks and the retardations of the first and second carrier retarders.

According to this configuration, at least one of the optical characteristic elements (optical activity, birefringence, and principal axis direction) of the measurement target in a predetermined wavelength band can be calculated by one measurement of light containing a specific band component. Therefore, the optical characteristics of the measurement target having wavelength dependence can be measured in a short period of time using a simple configuration.

When employing this configuration, the optical system may further include a spectroscope disposed between the light source and the light-receiving means (between the second polarizer and the light-receiving means), and may cause light dispersed into a spectrum by the spectroscope to be incident on the light-receiving means (light-receiving element).

In the invention, the calculation means may perform the spectrum extraction process before the optical characteristic element calculation process in a state in which a sample of which the retardation is known is provided in the optical system, and may calculate the retardations of the first and second carrier retarders as the known values based on the extracted spectral peaks.

Alternatively, the calculation means may perform the spectrum extraction process before the optical characteristic element calculation process in a state in which the measurement target or the measurement target and the first and second quarter-wave plates are not provided in the optical system, and may calculate the retardations of the first and second carrier retarders as the known values based on the extracted two spectral peaks.

According to the above configuration, even if the retardations of the first and second carrier retarders are unknown, the retardations of the first and second carrier retarders can be calculated by performing the above snap-shot measurement.

The optical characteristics of the measurement target can be measured by storing the calculated retardations of the carrier retarders in a given storage means of the calculation means as known values.

(2) In this optical characteristic measuring apparatus, the optical system may be set so that:

the principal axis direction of the first carrier retarder is rotated by 45° either clockwise or counterclockwise with respect to the principal axis direction of the first polarizer;

the principal axis direction of the first quarter-wave plate is rotated by 45° either clockwise or counterclockwise with respect to the principal axis direction of the first carrier retarder; and

the principal axis direction of the first quarter-wave plate is rotated by 0° or 90° either clockwise or counterclockwise with respect to the principal axis direction of the first polarizer.

(3) In this optical characteristic measuring apparatus, the optical system may be set so that:

the principal axis direction of the second carrier retarder is rotated by 45° either clockwise or counterclockwise with respect to the principal axis direction of the second polarizer;

the principal axis direction of the second quarter-wave plate is rotated by 45° either clockwise or counterclockwise with respect to the principal axis direction of the second carrier retarder; and

the principal axis direction of the second quarter-wave plate is rotated by 0° or 90° either clockwise or counterclockwise with respect to the principal axis direction of the second polarizer.

(4) In this optical characteristic measuring apparatus, when the retardations of the first and second carrier retarders are αδ and βδ, the retardations of the first and second carrier retarders may be set so that a ratio of (α+β) and (α−β) is two or more or ½ or less.

This enables the difference in frequency between the two spectral peaks to be sufficiently increased. Therefore, the optical characteristics of the measurement target can be measured more accurately.

(5) In this optical characteristic measuring apparatus, the calculation means may calculate at least one of the angle of rotation, the retardation, and the principal axis direction of the measurement target.

(6) In this optical characteristic measuring apparatus, the calculation means may subject the spectral peak extracted by the spectrum extraction process to Fourier analysis to calculate a real number component and an imaginary number component of the spectral peak, and may calculate the optical characteristic element of the measurement target based on the real number component and the imaginary number component of the spectral peak and the retardations of the first and second carrier retarders.

According to the above configuration, the optical characteristics of the measurement target can be calculated.

Specifically, two spectral peaks C_{δ1-δ2}(v) and C_{δ1+δ2}(v) are extracted from a Fourier spectrum obtained by subjecting the light intensity I(k) detected by the light-receiving means to Fourier analysis with respect to the wave number k in the spectrum extraction process, the two spectral peaks C_{δ1-δ2}(v) and C_{δ1+δ2}(v) are subjected to Fourier analysis in the characteristic calculation process to calculate the real number component and the imaginary number component of each spectral peak, and the angle of rotation ω(k), the retardation Δ(k), and the principal axis direction φ of the measurement target can be calculated based on equations (25) to (27) described later utilizing the fact that amp_{δ1-δ2(k), phase}_{δ1-δ2(k), amp}_{δ1+δ2(k), and phase}_{δ1-δ2(k) are expressed by an equation (}24-6) described later based on the real number component Re and the imaginary number component Im of each spectral peak and the retardations δ₁(k) and δ₂(k) of the first and second carrier retarders.

(7) Another optical characteristic measuring apparatus according to the invention is an optical characteristic measuring apparatus measuring optical characteristics of a measurement target, the optical characteristic measuring apparatus comprising:

an optical system including a carrier retarder of which the retardation is known and a quarter-wave plate without wavelength dependence, the optical system causing light emitted from a light source to be incident on the measurement target through a first polarizer, the carrier retarder, and the quarter-wave plate and modulated by the measurement target, and causing the modulated light to be incident on light-receiving means through a second polarizer; and

calculation means performing a spectrum extraction process of extracting a spectral peak from a frequency spectrum obtained by analyzing a light intensity signal detected by the light-receiving means, and an optical characteristic element calculation process of calculating an optical characteristic element representing the optical characteristics of the measurement target based on the extracted spectral peak and the retardation of the carrier retarder.

According to the invention, a configuration is employed in which light emitted from the light source is modulated by the optical elements and the measurement target utilizing the optical system formed by combining the carrier retarder of which the retardation is known, the quarter-wave plate without wavelength dependence, and the first and second polarizers.

Therefore, a frequency spectrum obtained by analyzing the light intensity signal of the measurement light detected by the light-receiving means contains a spectral peak reflecting the retardation of the carrier retarder and the optical characteristics of the measurement target.

Since the retardation of the carrier retarder is known in advance, the optical characteristic element of the measurement target can be calculated by substituting the value read from the spectral peak extracted from the frequency spectrum and the retardation of the carrier retarder in a theoretical equation (Fourier analysis theoretical equation) including a variable indicating the optical characteristic element of the measurement target.

In the invention, the frequency spectrum is obtained by analyzing the light intensity signal detected by the light-receiving means. Specifically, the invention requires obtaining a light intensity signal from which a frequency spectrum can be obtained by analysis.

Therefore, the optical characteristic measuring apparatus according to the invention may be configured to utilize a light source (white light source) which emits light containing a specific band component.

The optical characteristic measuring apparatus according to the invention may be configured as a measuring apparatus (optical characteristic measuring apparatus) in which Fourier analysis is applied to the analysis process and which measures at least the optical activity of the measurement target having optical transparency.

In this case, the optical characteristic measuring apparatus may be configured as a measuring apparatus which measures at least the optical activity of a measurement target having optical transparency, the optical characteristic measuring apparatus comprising:

an optical system including a carrier retarder of which the retardation is known and a quarter-wave plate without wavelength dependence, the optical system causing light containing a predetermined band component to be incident on the measurement target through a first polarizer, the carrier retarder, and the quarter-wave plate, and causing the light which has passed through the measurement target to be incident on light-receiving means through a second polarizer; and

calculation means for performing a spectrum extraction process of extracting a spectral peak from a Fourier spectrum obtained by subjecting a light intensity signal detected by the light-receiving means to Fourier analysis, and a characteristic calculation process of calculating at least the optical activity of the measurement target for the predetermined band component based on the extracted spectral peak and the retardation of the carrier retarder.

According to this configuration, the optical characteristic element of the measurement target in a predetermined wavelength band can be calculated by one measurement (snap-shot measurement) of the measurement light containing a specific band component. According to this configuration, an optical characteristic measuring apparatus can be provided which can accurately measure the optical characteristic element of the measurement target in a short period of time.

When employing this configuration, the optical system may further include a spectroscope disposed between the light source and the light-receiving means (between the second polarizer and the light-receiving means), and may cause light dispersed into a spectrum by the spectroscope to be incident on the light-receiving means (light-receiving element).

Moreover, the characteristic measuring apparatus according to the invention can measure the optical rotatory dispersion of the measurement target in one shot without utilizing mechanical or electrical driving. Specifically, the invention can provide a high-performance characteristic measuring apparatus having a simple configuration.

In the invention, the calculation means may perform the spectrum extraction process before the optical characteristic element calculation process in a state in which a sample of which the retardation is known is provided in the optical system, and may calculate the retardation of the carrier retarder as the known value based on the extracted spectral peak.

Alternatively, the calculation means may perform the spectrum extraction process before the optical characteristic element calculation process in a state in which the measurement target or the measurement target and the quarter-wave plate are not disposed in the optical system, and may calculate the retardation of the carrier retarder as the known value based on the extracted spectral peak.

According to the above configuration, even if the retardation of the carrier retarder is unknown, the retardation of the carrier retarder can be calculated by performing the above snap-shot measurement.

The optical characteristics of the measurement target can be measured by storing the calculated retardation of the carrier retarder in a given storage means of the calculation means as a known value.

(8) In this optical characteristic measuring apparatus, the optical system may be set so that:

the principal axis direction of the carrier retarder is rotated by 45° either clockwise or counterclockwise with respect to the principal axis direction of the first polarizer;

the principal axis direction of the quarter-wave plate is rotated by 45° either clockwise or counterclockwise with respect to the principal axis direction of the carrier retarder; and

the principal axis direction of the quarter-wave plate is rotated by 0° or 90° either clockwise or counterclockwise with respect to the principal axis direction of the first polarizer.

(9) In this optical characteristic measuring apparatus, the calculation means may calculate at least the angle of rotation of the measurement target.

(10) Another optical characteristic measuring apparatus according to the invention is an optical characteristic measuring apparatus measuring optical characteristics of a measurement target, the optical characteristic measuring apparatus comprising:

an optical system including a carrier retarder of which the retardation is known and a quarter-wave plate without wavelength dependence, the optical system causing light emitted from a light source to be incident on the measurement target through a first polarizer and modulated by the measurement target, and causing the modulated light to be incident on light-receiving means through the quarter-wave plate, the carrier retarder, and a second polarizer; and

calculation means performing a spectrum extraction process of extracting a spectral peak from a frequency spectrum obtained by analyzing a light intensity signal detected by the light-receiving means, and an optical characteristic element calculation process of calculating an optical characteristic element representing the optical characteristics of the measurement target based on the extracted spectral peak and the retardation of the carrier retarder.

According to the invention, a configuration is employed in which light emitted from the light source is modulated by the measurement target and the optical elements utilizing the optical system formed by combining the carrier retarder of which the retardation is known, the quarter-wave plate without wavelength dependence, and the first and second polarizers.

Therefore, a frequency spectrum obtained by analyzing the light intensity signal of the measurement light detected by the light-receiving means contains a spectral peak reflecting the retardation of the carrier retarder and the optical characteristics of the measurement target.

Since the retardation of the carrier retarder is known in advance, the optical characteristic element of the measurement target can be calculated by substituting the value read from the spectral peak extracted from the frequency spectrum and the retardation of the carrier retarder in a theoretical equation (Fourier analysis theoretical equation) including a variable indicating the optical characteristic element of the measurement target.

The optical characteristic measuring apparatus according to the invention may be configured to utilize a light source (white light source) which emits light containing a specific band component.

The optical characteristic measuring apparatus according to the invention may be configured as a device (optical characteristic measuring apparatus) in which Fourier analysis is applied to the analysis process and which measures at least the optical activity of the measurement target having optical transparency.

In this case, the optical characteristic measuring apparatus may be configured as a measuring apparatus which measures at least the optical activity of a measurement target having optical transparency, the optical characteristic measuring apparatus comprising:

an optical system including a carrier retarder of which the retardation is known and a quarter-wave plate without wavelength dependence, the optical system causing light containing a predetermined band component to be incident on the measurement target through a first polarizer, and causing the light which has passed through the measurement target to be incident on light-receiving means through the quarter-wave plate, the carrier retarder, and a second polarizer; and

calculation means for performing a spectrum extraction process of extracting a spectral peak from a Fourier spectrum obtained by subjecting a light intensity signal detected by the light-receiving means to Fourier analysis, and a characteristic calculation process of calculating at least the optical activity of the measurement target for the predetermined band component based on the extracted spectral peak and the retardation of the carrier retarder.

(11) In this optical characteristic measuring apparatus, the optical system may be set so that:

the principal axis direction of the carrier retarder is rotated by 45° either clockwise or counterclockwise with respect to the principal axis direction of the second polarizer;

the principal axis direction of the quarter-wave plate is rotated by 45° either clockwise or counterclockwise with respect to the principal axis direction of the carrier retarder; and

the principal axis direction of the quarter-wave plate is rotated by 0° or 90° either clockwise or counterclockwise with respect to the principal axis direction of the second polarizer.

(12) In this optical characteristic measuring apparatus, the calculation means may calculate at least the angle of rotation of the measurement target.

(13) Yet another optical characteristic measuring apparatus according to the invention is an optical characteristic measuring apparatus measuring optical characteristics of a measurement target, the optical characteristic measuring apparatus comprising:

an optical system including a carrier retarder of which the retardation is known and a quarter-wave plate without wavelength dependence, the optical system causing light emitted from a light source to be incident on the measurement target through a polarizer, the carrier retarder, and the quarter-wave plate and modulated by the measurement target, and causing the modulated light to be incident on light-receiving means; and

calculation means performing a spectrum extraction process of extracting a spectral peak from a frequency spectrum obtained by analyzing a light intensity signal detected by the light-receiving means, and an optical characteristic element calculation process of calculating an optical characteristic element representing the optical characteristics of the measurement target based on the extracted spectral peak and the retardation of the carrier retarder.

According to the invention, a configuration is employed in which light emitted from the light source is modulated by the optical elements and the measurement target utilizing the optical system formed by combining the carrier retarder of which the retardation is known, the quarter-wave plate without wavelength dependence, and the polarizer.

Therefore, a frequency spectrum obtained by analyzing the light intensity signal of the measurement light detected by the light-receiving means contains a spectral peak reflecting the retardation of the carrier retarder and the optical characteristics of the measurement target.

Since the retardation of the carrier retarder is known in advance, the optical characteristic element of the measurement target can be calculated by substituting the value read from the spectral peak extracted from the frequency spectrum and the retardation of the carrier retarder in a theoretical equation (Fourier analysis theoretical equation) including a variable indicating the optical characteristic element of the measurement target.

In the invention, light emitted from the measurement target may be incident on the light-receiving means without being modulated. Specifically, the optical system of the optical characteristic measuring apparatus according to the invention may have a configuration in which an optical element which modulates light is not disposed between the measurement target and the light-receiving means.

(14) In this optical characteristic measuring apparatus, the optical system may be set so that:

the principal axis direction of the carrier retarder is rotated by 45° either clockwise or counterclockwise with respect to the principal axis direction of the polarizer;

the principal axis direction of the quarter-wave plate is rotated by 45° either clockwise or counterclockwise with respect to the principal axis direction of the carrier retarder; and

the principal axis direction of the quarter-wave plate is rotated by 0 or 90° either clockwise or counterclockwise with respect to the principal axis direction of the polarizer.

(15) In this optical characteristic measuring apparatus, the calculation means may calculate at least the dichroism of the measurement target.

(16) In this optical characteristic measuring apparatus, the calculation means may subject the spectral peak extracted by the spectrum extraction process to Fourier analysis to calculate a real number component and an imaginary number component of the spectral peak, and may calculate the optical characteristic element of the measurement target based on the real number component and the imaginary number component of the spectral peak and the retardation of the carrier retarder.

According to the above configuration, the optical characteristic element of the measurement target can be calculated from the extracted spectral peak and the retardation of the carrier retarder.

Specifically, in the spectrum extraction process, the spectral peak C(v) may be extracted from the Fourier spectrum obtained by subjecting the light intensity I(k) detected by the light-receiving means to Fourier analysis with respect to the wave number k.

The phase component of the light intensity is separated from the direct-current component utilizing this spectral peak, and is expressed by an equation (13) described later.

In the optical characteristic element calculation process, the composite retardation Ω(k) may be calculated based on an equation (14) described later using a real number component Re and an imaginary number component Im of the spectral peak calculated by subjecting the spectral peak C(v) to Fourier analysis.

The angle of rotation ω(k) of the measurement target with respect to the wave number k may be calculated based on an equation (15) described later using the value calculated based on the equation (14) and the retardation δ(k) of the carrier retarder known in advance.

(17) In this optical characteristic measuring apparatus,

the light source may emit light containing a predetermined band component; and

the optical system may further include spectroscopic means which disperses the light containing the predetermined band component into a spectrum and causes the light dispersed into a spectrum to be incident on the light-receiving means.

In the invention, a frequency spectrum is obtained by analyzing the light intensity signal detected by the light-receiving means. Specifically, the invention requires obtaining a light intensity signal from which a frequency spectrum can be obtained by analysis. In other words, the invention requires setting the optical system so that light from which a frequency spectrum can be obtained by analysis is incident on the light-receiving means.

According to the above configuration, since the light source emits light containing a specific band component, the light intensity of each band component (wavelength component) can be obtained by dispersing the light into a spectrum and causing the light dispersed by the spectroscope to be incident on the light-receiving means. Since the intensity of the specific band component of the incident light can be obtained by associating light intensity information with band information (wavelength information), a frequency spectrum can be obtained by analyzing the light intensity. The spectroscope may be disposed adjacent to the light-receiving means on the upstream side. The spectroscope may be disposed between the second polarizer and the light-receiving means (light-receiving element), for example.

In this case, detection sections (light-receiving elements) which detect the light intensity may be two-dimensionally arranged in the light-receiving means, and the spectroscopic means may be set so that light dispersed into a spectrum is incident on different detection sections depending on each band component. The light intensity information which can be analyzed into a frequency spectrum can be obtained by associating the light intensity detected by each detection section with the light wavelength information (band information).

(18) In this optical characteristic measuring apparatus, the light source may sequentially emit first light to Mth light (M is an integer equal to or larger than two) which differ in band.

In the invention, a frequency spectrum is obtained by analyzing the light intensity signal. Specifically, the invention requires obtaining a light intensity signal from which a frequency spectrum can be obtained by analysis.

According to the above configuration, since the light source emits light with a different band (wavelength) (first light to Mth light), the light intensity in each band (wavelength) can be obtained by detecting the intensity of the respective incident light. Since the intensity (light intensity distribution) of a predetermined band component of incident light can be obtained by associating light intensity with band information (wavelength information), a frequency spectrum can be obtained by analyzing the light intensity.

In the invention, any device capable of emitting light with a different wavelength may be used as the light source of the optical system.

In the invention, the optical system may be configured to further include a spectroscopic means which disperses light containing a predetermined band component into a spectrum before the light is incident on the first polarizer and causes the light in each band to be incident on the first polarizer.

(19) In this optical characteristic measuring apparatus,

the light-receiving means may include two-dimensionally arranged light-receiving sections;

the optical system may include a light guide causing the light to be incident on the two-dimensionally arranged light-receiving sections of the light-receiving means; and

the calculation means may calculate the optical characteristics of the measurement target by performing the spectrum extraction process and the optical characteristic calculation process in units of the light-receiving sections of the light-receiving means.

According to this configuration, when causing light with a predetermined divergence to pass through a region of the measurement target with a predetermined width or area, the optical characteristics of that region can be measured in one shot.

In the invention, each light-receiving section may be configured to be able to obtain the intensity of incident light in frequency band units. For example, the light-receiving section may include a spectroscope which disperses incident light into a spectrum in frequency band units, and a detection section which detects the intensity of the incident light dispersed into a spectrum.

(20) An optical characteristic measuring method according to the invention is an optical characteristic measuring method for measuring optical characteristics of a measurement target, the optical characteristic measuring method comprising:

a process of providing first and second carrier retarders of which the retardations are known and differ from each other and first and second quarter-wave plates without wavelength dependence, causing light emitted from a light source to be incident on the measurement target through a first polarizer, the first carrier retarder, and the quarter-wave plate and modulated by the measurement target, and causing the modulated light to be incident on light-receiving means through the second quarter-wave plate, the second carrier retarder, and a second polarizer;

a spectrum extraction process of extracting a spectral peak from a frequency spectrum obtained by analyzing a light intensity signal detected by the light-receiving means; and

an optical characteristic element calculation process of calculating an optical characteristic element representing the optical characteristics of the measurement target based on the extracted spectral peak and the retardations of the first and second carrier retarders.

According to the invention, light modulated due to the effects of the first and second carrier retarders and the optical characteristics of the measurement target is analyzed. Therefore, a frequency spectrum obtained by analysis (e.g. Fourier analysis) contains spectral peaks reflecting the principal axis directions and the retardations of the first and second carrier retarders and the optical characteristics of the measurement target.

Since the retardations of the first and second carrier retarders are known in advance, the optical characteristic element of the measurement target can be calculated by substituting the value read from the spectral peak extracted from the frequency spectrum and the retardations of the first and second carrier retarders in a theoretical equation (Fourier analysis theoretical equation) including a variable indicating the optical characteristic element of the measurement target.

In the invention, the frequency spectrum is obtained by analyzing the light intensity signal detected by the light-receiving means. Specifically, the invention requires obtaining a light intensity signal from which a frequency spectrum can be obtained by analysis.

Therefore, the invention may utilize a light source (white light source) which emits light containing a specific band component as the light source.

The optical characteristic measuring method according to the invention may be configured as a measuring method (optical characteristic measuring method) in which Fourier analysis is applied to the analysis process and which measures at least one of the optical activity, the birefringence, and the principal axis direction of the measurement target having optical transparency.

In this case, the optical characteristic measuring method may be configured as a measuring method for measuring at least one of the optical activity, the birefringence, and the principal axis direction of a measurement target having optical transparency, the optical characteristic measuring method comprising:

a process of providing first and second carrier retarders of which the retardations are known and differ from each other and first and second quarter-wave plates without wavelength dependence, causing light containing a predetermined band component to be incident on the measurement target through a first polarizer, the first carrier retarder, and the quarter-wave plate, and causing the light which has passed through the measurement target to be incident on light-receiving means through the second quarter-wave plate, the second carrier retarder, and a second polarizer;

a spectrum extraction process of extracting a plurality of (two) spectral peaks from a Fourier spectrum obtained by subjecting a light intensity signal detected by the light-receiving means to Fourier analysis; and

a characteristic calculation process of calculating at least one of the optical activity, the birefringence, and the principal axis direction of the measurement target for the predetermined band component based on the extracted (two) spectral peaks and the retardations of the first and second carrier retarders.

(21) Another optical characteristic measuring method according to the invention is an optical characteristic measuring method for measuring optical characteristics of a measurement target, the optical characteristic measuring method comprising:

a process of providing a carrier retarder of which the retardation is known and a quarter-wave plate without wavelength dependence, causing light emitted from a light source to be incident on the measurement target through a first polarizer, the carrier retarder, and the quarter-wave plate and modulated by the measurement target, and causing the modulated light to be incident on light-receiving means through a second polarizer;

a spectrum extraction process of extracting a spectral peak from a frequency spectrum obtained by analyzing a light intensity signal detected by the light-receiving means; and

an optical characteristic element calculation process of calculating an optical characteristic element representing the optical characteristics of the measurement target based on the extracted spectral peak and the retardation of the carrier retarder.

According to the invention, light modulated due to the effects of the carrier retarder and the optical characteristics of the measurement target is analyzed. Therefore, a frequency spectrum obtained by analysis (e.g. Fourier analysis) contains spectral peaks reflecting the principal axis direction and the retardation of the carrier retarder and the optical characteristics of the measurement target.

Since the retardation of the carrier retarder is known in advance, the optical characteristic element of the measurement target can be calculated by substituting the value read from the spectral peak extracted from the frequency spectrum and the retardation of the carrier retarder in a theoretical equation (Fourier analysis theoretical equation) including a variable indicating the optical characteristic element of the measurement target.

In the invention, the frequency spectrum is obtained by analyzing the light intensity signal detected by the light-receiving means. Specifically, the invention requires obtaining a light intensity signal from which a frequency spectrum can be obtained by analysis.

Therefore, the invention may utilize a light source (white light source) which emits light containing a specific band component as the light source.

The optical characteristic measuring method according to the invention may be configured as a measuring method (optical characteristic measuring method) in which Fourier analysis is applied to the analysis process and which measures at least the optical activity of the measurement target having optical transparency.

In this case, the optical characteristic measuring method may be configured as a measuring method for measuring at least the optical activity of a measurement target having optical transparency, the optical characteristic measuring method comprising:

a process of providing a carrier retarder of which the retardation is known and a quarter-wave plate without wavelength dependence, causing light containing a predetermined band component to be incident on the measurement target through a first polarizer, the carrier retarder, and the quarter-wave plate, and causing the light which has passed through the measurement target to be incident on light-receiving means through a second polarizer;

a spectrum extraction process of extracting a spectral peak from a Fourier spectrum obtained by subjecting a light intensity signal detected by the light-receiving means to Fourier analysis; and

a characteristic calculation process of calculating at least the optical activity of the measurement target for the predetermined band component based on the extracted spectral peak and the retardation of the carrier retarder.

(22) Another optical characteristic measuring method according to the invention is an optical characteristic measuring method for measuring optical characteristics of a measurement target, the optical characteristic measuring method comprising:

a process of providing a carrier retarder of which the retardation is known and a quarter-wave plate without wavelength dependence, causing light emitted from a light source to be incident on the measurement target through a first polarizer and modulated by the measurement target, and causing the modulated light to be incident on light-receiving means through the quarter-wave plate, the carrier retarder, and a second polarizer;

a spectrum extraction process of extracting a spectral peak from a frequency spectrum obtained by analyzing a light intensity signal detected by the light-receiving means; and

an optical characteristic element calculation process of calculating an optical characteristic element representing the optical characteristics of the measurement target based on the extracted spectral peak and the retardation of the carrier retarder.

According to the invention, light modulated due to the effects of the carrier retarder and the optical characteristics of the measurement target is analyzed. Therefore, a frequency spectrum obtained by analysis (e.g. Fourier analysis) contains spectral peaks reflecting the principal axis direction and the retardation of the carrier retarder and the optical characteristics of the measurement target.

Since the retardation of the carrier retarder is known in advance, the optical characteristic element of the measurement target can be calculated by substituting the value read from the spectral peak extracted from the frequency spectrum and the retardation of the carrier retarder in a theoretical equation (Fourier analysis theoretical equation) including a variable indicating the optical characteristic element of the measurement target.

In the invention, the frequency spectrum is obtained by analyzing the light intensity signal detected by the light-receiving means. Specifically, the invention requires obtaining a light intensity signal from which a frequency spectrum can be obtained by analysis.

Therefore, the invention may utilize a light source (white light source) which emits light containing a specific band component as the light source.

The optical characteristic measuring method according to the invention may be configured as a measuring method (optical characteristic measuring method) in which Fourier analysis is applied to the analysis process and which measures at least the optical activity of the measurement target having optical transparency.

In this case, the optical characteristic measuring method may be configured as a measuring method for measuring at least the optical activity of a measurement target having optical transparency, the optical characteristic measuring method comprising:

a process of providing a carrier retarder of which the retardation is known and a quarter-wave plate without wavelength dependence, causing light containing a predetermined band component to be incident on the measurement target through a first polarizer, and causing the light which has passed through the measurement target to be incident on light-receiving means through the quarter-wave plate, the carrier retarder, and a second polarizer;

a spectrum extraction process of extracting a spectral peak from a Fourier spectrum obtained by subjecting a light intensity signal detected by the light-receiving means to Fourier analysis; and

a characteristic calculation process of calculating at least the optical activity of the measurement target for the predetermined band component based on the extracted spectral peak and the retardation of the carrier retarder.

(23) Yet another optical characteristic measuring method according to the invention is an optical characteristic measuring method for measuring optical characteristics of a measurement target, the optical characteristic measuring method comprising:

a process of providing a carrier retarder of which the retardation is known and a quarter-wave plate without wavelength dependence, causing light emitted from a light source to be incident on the measurement target through a polarizer, the carrier retarder, and the quarter-wave plate and modulated by the measurement target, and causing the modulated light to be incident on light-receiving means;

a spectrum extraction process of extracting a spectral peak from a frequency spectrum obtained by analyzing a light intensity signal detected by the light-receiving means; and

an optical characteristic element calculation process of calculating an optical characteristic element representing the optical characteristics of the measurement target based on the extracted spectral peak and the retardation of the carrier retarder.

According to the invention, light modulated due to the effects of the carrier retarder and the optical characteristics of the measurement target is analyzed. Therefore, a frequency spectrum obtained by analysis (e.g. Fourier analysis) contains spectral peaks reflecting the principal axis direction and the retardation of the carrier retarder and the optical characteristics of the measurement target.

Since the retardation of the carrier retarder is known in advance, the optical characteristic element of the measurement target can be calculated by substituting the value read from the spectral peak extracted from the frequency spectrum and the retardation of the carrier retarder in a theoretical equation (Fourier analysis theoretical equation) including a variable indicating the optical characteristic element of the measurement target.

In the invention, the dichroism of the measurement target may be calculated as the optical characteristic element of the measurement target.

In the invention, light emitted from the measurement target may be incident on the light-receiving means without being modulated. Specifically, in the invention, an optical element which modulates light may not be disposed between the measurement target and the light-receiving means.

(24) In this optical characteristic measuring method,

the light source may emit light containing a predetermined band component; and

the light modulation process may include dispersing the light containing a predetermined band component into a spectrum and causing the light dispersed into a spectrum to be incident on the light-receiving means.

In the invention, a frequency spectrum is obtained by analyzing the light intensity signal. Specifically, the invention requires obtaining a light intensity signal from which a frequency spectrum can be obtained by analysis.

According to the above configuration, since the light source emits light containing a specific band component, the light intensity of each band component (wavelength component) can be obtained by dispersing the light into a spectrum and causing the light dispersed into a spectrum to be incident on the light-receiving means. Since the intensity of the specific band component of the incident light can be obtained by associating light intensity information with band information (wavelength information), a frequency spectrum can be obtained by analyzing the light intensity.

(25) In this optical characteristic measuring method, the light source may sequentially emit first light to Mth light (M is an integer equal to or larger than two) which differ in band.

In the invention, a frequency spectrum is obtained by analyzing the light intensity signal. Specifically, the invention requires obtaining a light intensity signal from which a frequency spectrum can be obtained by analysis.

According to the above configuration, since the light source emits light with a different band (wavelength) (first light to Mth light), the light intensity in each band (wavelength) can be obtained by detecting the intensity of the respective incident light. Since the intensity (light intensity distribution) of a specific band component of incident light can be obtained by associating light intensity with band information (wavelength information), a frequency spectrum can be obtained by analyzing the light intensity.

### BRIEF DESCRIPTION OF THE DRAWINGS

FIG. 1 is a diagram illustrative of an optical characteristic measuring apparatus according to a first embodiment of the invention.

FIG. 2 is a diagram illustrative of the principle according to the first embodiment.

FIG. 3 is a diagram illustrative of a photodetector of an optical system.

FIG. 4 is a diagram illustrative of light emitted from a carrier retarder.

FIG. 5 is a diagram illustrative of light emitted from a quarter-wave plate.

FIG. 6 shows an example of measurement data of a light intensity signal.

FIG. 7 is a graph showing a Fourier spectrum obtained from a light intensity signal.

FIG. 8A is a graph showing the light intensity before inserting a sample.

FIG. 8B is a graph showing the light intensity after inserting a sample A.

FIG. 8C is a graph showing the light intensity after inserting a sample B.

FIG. 9 is a graph showing the wavelength distribution of the composite phase shown by an equation (9).

FIG. 10 is a graph showing the wavelength distribution of the angle of rotation shown by an equation (15).

FIG. 11 is a table showing comparison data of design values and measured values of an optical activity standard sample.

FIG. 12 is a flowchart showing an optical characteristic measurement process according to the first embodiment.

FIG. 13 is a flowchart showing an optical characteristic measurement process according to a modification of the first embodiment.

FIG. 14 is a diagram illustrative of an optical characteristic measuring apparatus according to a second embodiment.

FIG. 15 is a diagram illustrative of a measurement sample as a measurement target of a third embodiment.

FIG. 16 is a diagram illustrative of an optical characteristic measuring apparatus according to the third embodiment.

FIG. 17 is a diagram illustrative of the principle of the third embodiment.

FIG. 18 is a graph showing a Fourier spectrum obtained from a light intensity signal.

FIG. 19 is a diagram illustrative of a measurement sample prepared for measurement evaluation and having optical rotatory dispersion and birefringence dispersion.

FIG. 20 shows measurement data of the light intensity distribution obtained before and after inserting the measurement sample shown in FIG. 19.

FIG. 21 shows measured values of the amplitude components of frequencies δ₁−δ₂ and δ₁+δ₂.

FIG. 22 shows the wavelength characteristics of the optical rotatory dispersion of the measurement sample shown in FIG. 19.

FIG. 23 shows the wavelength characteristics of the birefringence dispersion of the measurement sample shown in FIG. 19.

FIG. 24 shows the wavelength characteristics of the principal axis direction of the measurement sample shown in FIG. 19.

FIG. 25 is a flowchart showing an optical characteristic measurement process according to the third embodiment.

FIG. 26 is a diagram illustrative of an optical characteristic measuring apparatus according to a fourth embodiment.

FIG. 27 shows an example of measurement data of a light intensity signal.

FIG. 28 is a flowchart showing an optical characteristic measurement process according to the fourth embodiment.

FIG. 29 shows verification experiment results of the optical characteristic measurement process according to the fourth embodiment.

### BEST MODE FOR CARRYING OUT THE INVENTION

Embodiments of the invention are described below with reference to the drawings.

### 1. First Embodiment

A case of applying the invention to a system which measures the optical rotatory dispersion (optical characteristics in a broad sense) of a measurement target in one shot is described below as a first embodiment.

### 1.1. Configuration of Optical Characteristic Measuring Apparatus

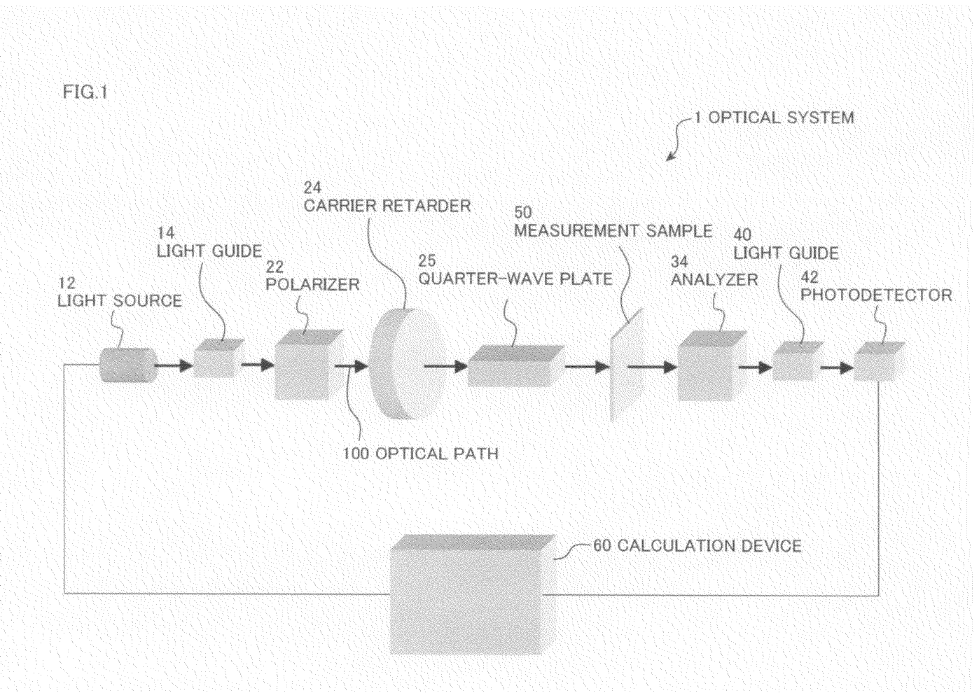

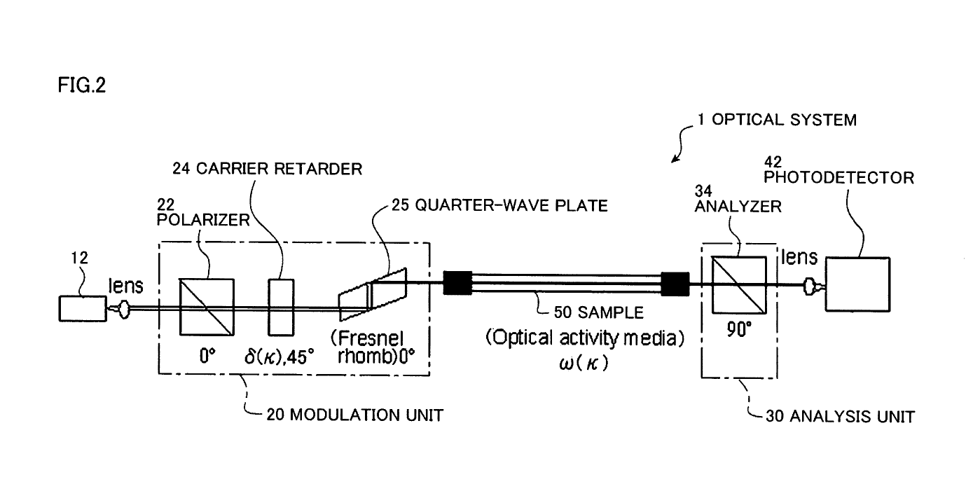

FIGS. 1 and 2 are diagrams illustrative of an optical characteristic measuring apparatus according to this embodiment.

The optical characteristic measuring apparatus according to this embodiment optically measures the optical rotatory dispersion of a measurement sample 50 (measurement target). In this embodiment, the measurement sample 50 has optical transparency. The optical characteristic measuring apparatus according to this embodiment includes an optical system 1 and a calculation device 60.

### 1.1.1. Optical System 1

As shown in FIGS. 1 and 2, the optical characteristic measuring apparatus according to this embodiment includes the optical system 1. The optical system 1 is configured as follows.

The optical system 1 includes a light source 12 and a photodetector 42.

The optical system 1 further includes a light guide 14, a polarizer 22, a carrier retarder 24, a quarter-wave plate 25 without wavelength dependence, the measurement sample 50 (measurement target), an analyzer 34, and a light guide 40 disposed in an optical path 100 connecting the light source 12 and the photodetector 42. The analyzer 34 may be referred to as a polarizer which makes a pair with the polarizer 22. Specifically, the polarizer 22 may be referred to as a first polarizer, and the analyzer 34 may be referred to as a second polarizer. An optical system which does not include the light guides 14 and 40 may be used as the optical system 1. These optical elements (optical devices) are described below.

The light source 12 generates and emits light containing a predetermined wavelength (wave number k) band component. In this embodiment, a white light source such as a halogen lamp may be used as the light source 12.

The light guide 14 is an optical device which vertically and/or horizontally enlarges the diameter of light emitted from the light source 12. The light guide 14 may enlarge the light emitted from the light source 12 to a diameter corresponding to the measurement sample 50.

The polarizer 22 is an incident-side polarizer which makes a pair with the analyzer 34 and linearly polarizes the light emitted from the light guide 14.

The analyzer 34 is an exit-side polarizer which makes a pair with the polarizer 22 and linearly polarizes the light which has passed through the measurement sample 50.

As the carrier retarder 24, a carrier retarder is used of which the retardation differs depending on the wavelength of light passing through the carrier retarder 24. Therefore, the polarization state of light which passes through the carrier retarder 24 changes depending on the wavelength.

The carrier retarder 24 may be formed using a high-order retardation plate, for example. In this embodiment, the retardation of the carrier retarder 24 is known.

The quarter-wave plate 25 is a wave plate without wavelength dependence. A Fresnel rhomb may be used as the quarter-wave plate without wavelength dependence, for example. A composite wave plate using a synthetic quartz and magnesium fluoride (MgF₂) in combination may also be used as the quarter-wave plate without wavelength dependence. In the optical characteristic measuring apparatus according to this embodiment, a Fresnel rhomb is used as the quarter-wave plate 25.

The polarization plane of linearly polarized light changes when passing through the quarter-wave plate 25 without wavelength dependence.

The carrier retarder 24 may be set so that its principal axis direction differs from the principal axis direction of the polarizer 22 by 45° either clockwise or counterclockwise. The quarter-wave plate 25 may be set so that its principal axis direction differs from the principal axis direction of the carrier retarder 24 by 45° either clockwise or counterclockwise. The quarter-wave plate 25 may be set so that its principal axis direction differs from the principal axis direction of the polarizer 22 by 0° or 90° either clockwise or counterclockwise. This enables a highly accurate measurement.

The analyzer 34 may be set so that its principal axis direction differs from the principal axis direction of the polarizer 22 by 0° or 90° either clockwise or counterclockwise. This enables utilization of a simple calculation equation, whereby good measurement results can be obtained. Note that the angular difference in principal axis direction between the analyzer 34 and the polarizer 22 may be arbitrarily set.

The polarization plane of light which passes through the optical system 1 changes depending on the wavelength. The details are described later.

FIG. 2 is a diagram showing the optical arrangement of the measurement sample 50, the polarizer 22, the carrier retarder 24, the quarter-wave plate 25, and the analyzer 34 in the optical path 100. Note that the light guides 14 and 40 are omitted for convenience of description.

In this embodiment, when the principal axis direction of the polarizer 22 is 0°, the principal axis directions of the carrier retarder 24, the quarter-wave plate 25, and the analyzer 34 are rotated clockwise by 45°, 0°, and 90°, respectively.

The polarizer 22, the carrier retarder 24, and the quarter-wave plate 25 positioned on the incident side of the measurement sample 50 may form a modulation unit 20. The analyzer 34 positioned on the exit side of the measurement sample 50 may form an analysis unit 30.

The measurement sample 50 is disposed in the optical path 100 between the quarter-wave plate 25 and the analyzer 34. The measurement sample 50 is an optical material having optical transparency. In this embodiment, an optically active substance having optical activity is used as the measurement sample 50. Therefore, light which passes through the measurement sample 50 is modulated due to the optical activity of the measurement sample 50. The measurement sample 50 may be a liquid optically active substance. The measurement sample 50 may be enclosed in a glass tube or the like. The glass tube may have a structure in which light is incident on one end and is emitted from the other end.

Although this embodiment aims at a liquid optically active substance as the measurement sample 50, the invention is not limited thereto. Specifically, a solid optically active substance having optical transparency may be used as the measurement sample 50 according to the invention. An optical material without optical transparency may also be used as the measurement sample 50. In this case, light may be modulated by allowing the measurement sample 50 to reflect the light.

### 1.1.2. Photodetector 42 as Light-Receiving Means

The optical system 1 includes the photodetector 42. The photodetector 42 is configured as follows. The photodetector 42 functions as a light-receiving means, and may include a CCD 44 in which light-receiving sections 45 (light-receiving elements) photoelectrically converting obtained light (incident light) are arranged two-dimensionally.

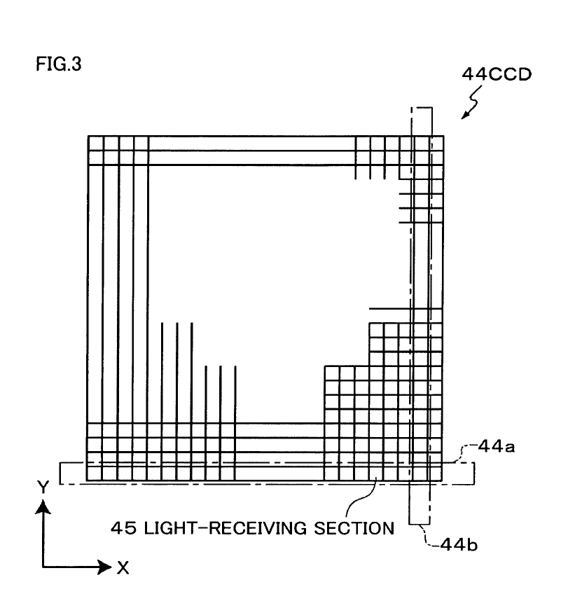

FIG. 3 is a diagram showing an example of the two-dimensional arrangement of the light-receiving sections 45 of the CCD 44 according to this embodiment. In the CCD 44 according to this embodiment, the light-receiving sections 45 are arranged in the X-axis direction and the Y-axis direction in a matrix. Each light-receiving section column 44a extending in the X-axis direction is associated with each position of the measurement sample 50 along the longitudinal direction. Each light-receiving section row 44b extending in the Y-axis direction is associated with each position of the measurement sample 50 along the lateral direction.

Light which has passed through the measurement sample 50 and then passed through the second carrier retarder 32 and the analyzer 34 is guided by the light guide 40 to be incident on each light-receiving section 45 of the CCD 44 corresponding to the longitudinal direction and the lateral direction of the measurement sample 50.

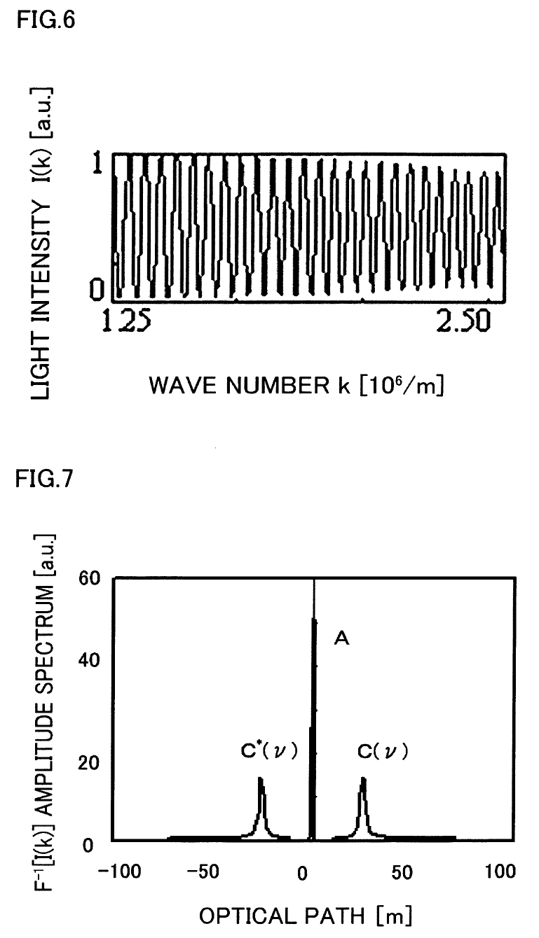

FIG. 6 shows an example of the light intensity I(k) detected by the photodetector 42. Equations (8) and (9) described later are theoretical equations of the light intensity I(k) detected by the photodetector 42. The light intensity I(k) obtained by the photodetector 42 is expressed as a function of the angle of rotation ω(k) of the measurement sample 50, as shown by the equations (8) and (9).

### 1.1.3. Calculation Device 60

The calculation device 60 calculates the angle of rotation ω(k) of the measurement sample 50 for a predetermined band component based on a light intensity signal I(k) of light received by the photodetector 42.

The calculation device 60 may be implemented using a computer. The term “computer” used herein refers to a physical device (system) including a processor (processing section: CPU or the like), a memory (storage section), an input device, and an output device as basic elements.

The calculation device 60 as a computer includes a processing section. The processing section performs various processes according to this embodiment based on a program (data) stored in an information storage medium. Specifically, a program for causing a computer to function (program for causing a computer to execute a process of each section) is stored in the information storage medium. The function of the processing section may be implemented by hardware such as a processor (e.g. CPU or DSP) or ASIC (e.g. gate array) and a program.

The calculation device 60 as a computer includes a storage section. The storage section serves as a work area for the processing section and the like. The function of the storage section may be implemented by a RAM or the like.

The calculation device 60 as a computer may include an information storage medium. The information storage medium (computer-readable medium) stores a program, data, and the like. The function of the information storage medium may be implemented by an optical disk (CD or DVD), a magneto-optical disk (MO), a magnetic disk, a hard disk, a magnetic tape, a memory (ROM), or the like.

### 1.2. Optical Characteristic Measurement Principle

The principle of the optical characteristic measuring apparatus according to this embodiment is described below.

### 1.2.1. White Light Modulation Principle Using Optical System 1

White light emitted from the light source 12 passes through the polarizer 22, the carrier retarder 24, and the quarter-wave plate 25, as shown in FIGS. 1 and 2.

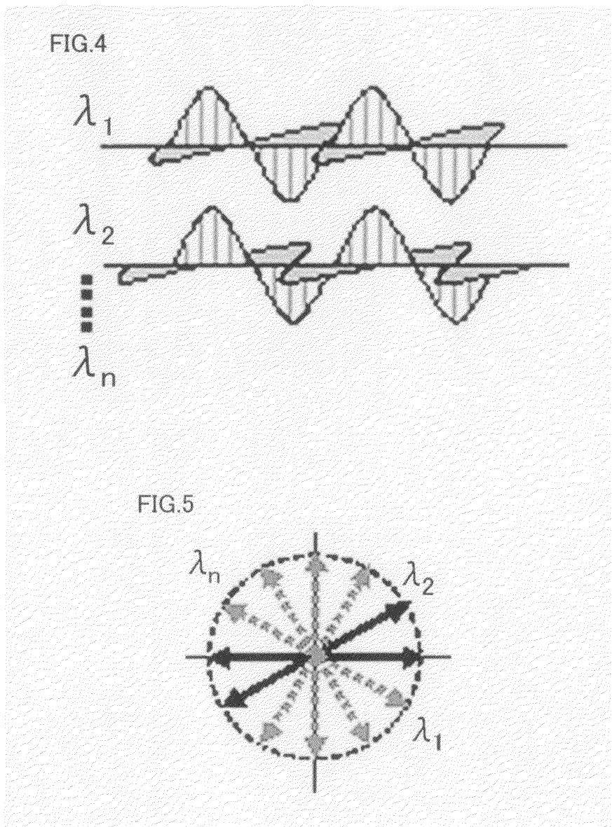

Since the carrier retarder 24 formed as a birefringent plate has a strong birefringence dispersion, the birefringence of the carrier retarder 24 differs depending on the wavelength of light which passes through the carrier retarder 24. Therefore, the retardation of light which passes through the carrier retarder 24 changes depending on the wavelength (λ1, λ2, . . . , and λn), as shown in FIG. 4.

The linearly polarized light (polarization plane of linearly polarized light) contained in the light having a polarization state which differs depending on the wavelength (in wavelength units) (light which has passed through the carrier retarder 24; see FIG. 4) changes when passing through the quarter-wave plate 25 without wavelength dependence, as shown in FIG. 5. Specifically, the polarization plane of the linearly polarized light contained in the light emitted from the quarter-wave plate 25 differs depending on the wavelength (λ1, λ2, . . . , and λn), as shown in FIG. 5.

In this embodiment, light which has passed through the polarizer 22 is modulated to light of which the retardation and the polarization plane of the linearly polarized light have changed depending on the wavelength (i.e., spectroscopic polarization-modulated light) while passing through the carrier retarder 24 and the quarter-wave plate 25.

When the spectroscopic polarization-modulated light passes through the measurement sample 50 having optical activity, the polarization plane of the linearly polarized light further changes depending on the wavelength due to the optical activity of the measurement sample 50.

The light which has passed through the measurement sample 50 passes through the analyzer 34 positioned on the downstream side of the measurement sample 50, and is then incident on the photodetector 42 as measurement light so that the light intensity is detected.

In this embodiment, the light source 12 emits light (white light) containing a predetermined band component. Therefore, light which passes through the analyzer 34 also contains the predetermined band component. The light intensity in wave number k units shown in FIG. 6 can be obtained by dispersing the light emitted from the analyzer 34 into a spectrum in wave number k units and measuring the light intensity (spectral intensity).

In order to implement the above configuration, the photodetector 42 may include a spectroscopic means (spectroscope) for dispersing the measurement light into a spectrum, and a light-receiving means (measuring means/light-receiving element) for measuring the light intensity. The photodetector 42 may be configured to obtain the light intensity in wave number k units by measuring the intensity of light dispersed into a spectrum by the spectroscope (e.g. prism or diffraction grating) using the light-receiving means. The light-receiving means may have a structure in which light-receiving elements photoelectrically converting the incident light are disposed in parallel in rows and/or columns. The intensity of the measurement light in wave number units can be detected by assigning each light-receiving element to one of the wave numbers. In this case, the spectroscope and the light-receiving means (light-receiving element) may be collectively referred to as a light-receiving spectroscope (light-receiving/spectroscopic means). The optical system (photodetector 42) may include two or more light-receiving spectroscopes. The light intensity in a predetermined region of the measurement sample 50 can be obtained by associating each light-receiving spectroscope with each position of the measurement sample 50. The light-receiving spectroscopes may be arranged in one row or column. Alternatively, the light-receiving spectroscopes may be arranged in rows and columns.

### 1.2.2. Mueller Matrix of Optical System 1 and Optical Characteristic Measurement Principle Using the Same

The Mueller matrices of the optical system 1 are expressed as follows.

An equation (1) indicates the Stokes parameter Sᵢₙ of incident light, and equations (2) to (6) respectively indicate the Mueller matrices of the elements forming the optical system 1 (i.e., the polarizer 22, the carrier retarder 24, the quarter-wave plate 25, the measurement sample 50, and the analyzer 34).

$$\begin{matrix}{S}_{i n} = [ \begin{matrix}{s}_{0} \\ {s}_{1} \\ {s}_{2} \\ {s}_{3}\end{matrix} ] = [ \begin{matrix}1 \\ 0 \\ 0 \\ 0\end{matrix} ] & ( 1 ) \\ {P}_{0 °} = \frac{1}{2} [ \begin{matrix}1 & 1 & 0 & 0 \\ 1 & 1 & 0 & 0 \\ 0 & 0 & 0 & 0 \\ 0 & 0 & 0 & 0\end{matrix} ] & ( 2 ) \\ {R}_{δ ( k ) , 45 °} = [ \begin{matrix}1 & 0 & 0 & 0 \\ 0 & cos δ ( k ) & 0 & - sin δ ( k ) \\ 0 & 0 & 1 & 0 \\ 0 & sin δ ( k ) & 0 & cos δ ( k )\end{matrix} ] & ( 3 ) \\ {FR}_{0 °} = [ \begin{matrix}1 & 0 & 0 & 0 \\ 0 & 1 & 0 & 0 \\ 0 & 0 & 0 & 1 \\ 0 & 0 & - 1 & 0\end{matrix} ] & ( 4 ) \\ {T}_{ω ( k )} = [ \begin{matrix}1 & 0 & 0 & 0 \\ 0 & cos 2 ω ( k ) & - sin 2 ω ( k ) & 0 \\ 0 & sin 2 ω ( k ) & cos 2 ω ( k ) & 0 \\ 0 & 0 & 0 & 1\end{matrix} ] & ( 5 ) \\ {A}_{90 °} = \frac{1}{2} [ \begin{matrix}1 & - 1 & 0 & 0 \\ - 1 & 1 & 0 & 0 \\ 0 & 0 & 0 & 0 \\ 0 & 0 & 0 & 0\end{matrix} ] & ( 6 )\end{matrix}$$

where, δ(k) indicates the retardation of the carrier retarder 24, and ω(k) indicates the angle of rotation of the optically active substance which is the measurement sample 50.

The relationship between each Mueller matrix and the Stokes parameter is given by the following equation.

Sₒᵤₜ=A_{90°}·T_{ω(k)}·FR_{0°}·R_{δ(k),45°}·P_{0°}·Sᵢₙ

The light intensity obtained by the photodetector 42 is expressed as follows using the equation (7).

$$\begin{matrix}I ( k ) = \frac{{I}_{0}}{4} ( 1 - cos ( Ω ( k ) ) ) & ( 8 ) \\ Ω ( k ) = δ ( k ) + 2 ω ( k ) & ( 9 )\end{matrix}$$

where, I₀ indicates the maximum light intensity, and Ω(k) indicates the composite phase due to the retardation of the carrier retarder 24 and the angle of rotation of the measurement sample 50.

k indicates the wave number which is the reciprocal of the wavelength k. Specifically, the equations (8) and (9) contain information relating to the angle of rotation ω(k) of the measurement sample 50 in a given wavelength band (wave number k). Therefore, the wavelength dependence ω(k) of the angle of rotation can be measured by utilizing the light intensity obtained by the photodetector 42.

FIG. 6 shows an example of the intensity of light received by the photodetector 42 in the optical system 1. In FIG. 6, the vertical axis indicates the light intensity I(k), and the horizontal axis indicates the wave number k. As shown in FIG. 6, it is confirmed that the light intensity detected by the photodetector 42 is modulated by different frequencies. Specifically, the light intensity detected by the photodetector 42 differs depending on the frequency.

Expanding the equation (8) using Euler's formula yields the following equations.

$$\begin{matrix}I ( k ) = a + c ( k ) + {c}^{*} ( k ) & ( 10 ) \\ c ( k ) = \frac{1}{2} b ( k ) exp ( iΩ ( k ) ) & ( 11 )\end{matrix}$$

where, a, b(k), and c(k) respectively indicate a direct-current component, an amplitude component, and an alternating-current component. c*(k) indicates a conjugate component of the alternating-current component c(k).

Subjecting the equation (10) to inverse Fourier transformation with respect to the wave number k yields the following equation.

I(v)=A+C(v)+C*(v) (12)

FIG. 7 shows the Fourier spectrum (frequency spectrum in a broad sense) shown by the equation (12). In FIG. 7, the horizontal axis indicates the frequency, and the vertical axis indicates the amplitude spectrum.

As shown in FIG. 7, in the Fourier spectrum obtained by subjecting the light intensity I(k) modulated by the optical element included in the optical system 1 to inverse Fourier transformation with respect to the wave number k, a spectral peak A of the direct-current component appears in the region in which the frequency is 0, and a spectral peak C(v) appears in the region in which the frequency is δ(v).

### 1.2.3. Utilization of Measured Values

In this embodiment, the light intensity I(k) detected by the photodetector 42 is used for calculations as described below.

Specifically, a Fourier spectrum is obtained by subjecting the light intensity I(k) shown in FIG. 6 to inverse Fourier transformation with respect to the wave number k, and the spectral peak C(v) is extracted from the Fourier spectrum and subjected to Fourier transformation.

This enables the phase component of the light intensity to be separated from the direct-current component, as shown by the following equation.

$${F}^{- 1} [ C ( v ) ] = c ( k ) = \frac{1}{2} b ( k ) exp ( iΩ ( k ) ) \qquad ( 13 )$$

Specifically, the value of the equation (13) can be determined as the measured value from the light intensity signal I(k) detected by the photodetector 42. A real number component Re[c(k)] and an imaginary number component Im[c(k)] of the spectral peak can be determined as measured values utilizing the equation (13) and the measured values.

The spectral peak can be extracted by filtering the Fourier spectrum.

### 1.2.4. Calculation of Angle of Rotation ω(k) of Measurement Sample 50 Using Measured Values

The composite retardation Ω(k) due to the carrier retarder 24 and the angle of rotation of the measurement sample 50 is expressed by the following equation from the real number component Re[c(k)] and the imaginary number component Im[c(k)] of the spectral peak.

$$Ω ( k ) = {tan}^{- 1} [ \frac{Im [ c ( k ) ]}{Re [ c ( k ) ]} ] \qquad ( 14 )$$

The angle of rotation E(k) of the measurement sample 50 is expressed by the following equation referring to the equations (9) and (14).

$$ω ( k ) = \frac{1}{2} ( {tan}^{- 1} [ \frac{Im [ c ( k ) ]}{Re [ c ( k ) ]} ] - δ ( k ) ) \qquad ( 15 )$$

In the equation (15), δ(k) is known as the retardation of the carrier retarder 24. The real number component Re[c(k)] and the imaginary number component Im[c(k)] of the spectral peak can be determined from the measured values, as described above. Therefore, the angle of rotation ω(k) of the measurement sample 50 with respect to the wavelength k can be calculated by substituting these values in the equation (15).

### 1.3. Effect

The angle of rotation of the measurement sample 50 shows wavelength dependence in the same manner as the dispersion of the refractive index. This phenomenon is called optical rotatory dispersion. Since the optical rotatory dispersion has wavelength characteristics specific to a substance, the optical rotatory dispersion is important for characteristic analysis and structural analysis.

In this embodiment, light containing a predetermined wavelength band component is used as the measurement light, and the angle of rotation of the measurement sample 50 for the predetermined band component can be obtained as optical rotatory dispersion characteristics by snap-shot measurement. Therefore, the angle of rotation can be easily measured within a short period of time as compared with the related-art methods.

This embodiment also exhibits an excellent effect in which the optical rotatory dispersion of the measurement sample 50 can be determined by one measurement without requiring special electrical/mechanical control.

### 1.4. Optical Characteristic Measurement Process

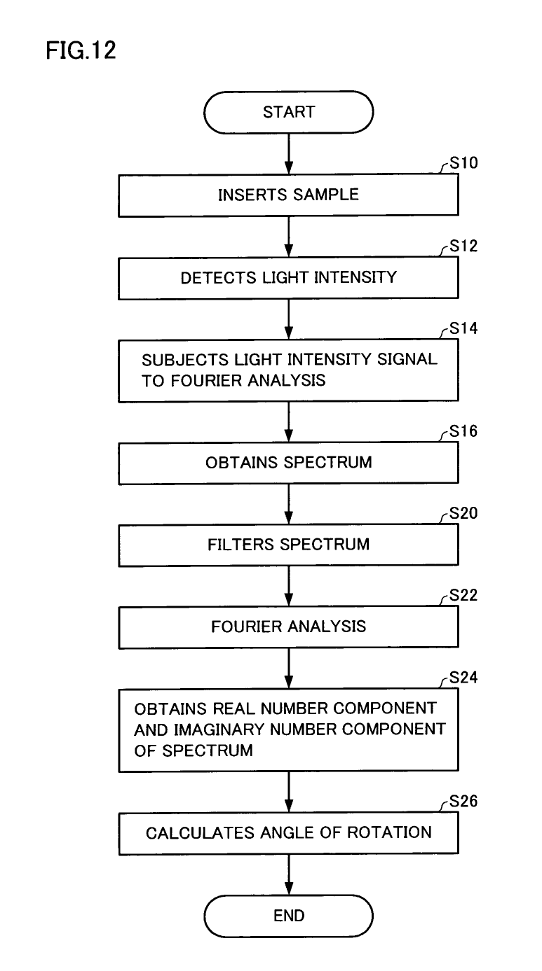

An optical characteristic measurement process employed for the optical characteristic measuring apparatus according to the embodiment is described below. FIG. 12 is a flowchart showing the optical characteristic measurement process.

The measurement sample 50 is inserted into the optical path 100 of the optical system 1 (step S10).

Light is emitted from the light source 12, and the photodetector 42 receives the light modulated by the optical elements and the measurement sample 50 included in the optical system 1 to detect the light intensity (step S12). When the photodetector 42 includes two or more light-receiving spectroscopes, the light intensity distribution data shown in FIG. 6 is obtained in units of the light-receiving spectroscopes.

The light intensity signal is then subjected to Fourier transformation (inverse Fourier transformation) with respect to the wave number k as shown by the equation (12) (step S14) to obtain a spectrum (Fourier spectrum or frequency spectrum) (step S16). As shown in FIG. 7, the Fourier spectrum thus obtained contains the spectral peak C(v) which reflects the retardation δ(k) specific to the carrier retarder 24.

The spectrum is then filtered (step S20). This allows the spectral peak C(v) to be extracted from the Fourier spectrum. This step may be performed by filtering.

In the subsequent step S22, the spectral peak C(v) thus extracted is subjected to Fourier analysis (e.g. FFT).

As described above, the spectral peak is extracted as the measured value in the steps S12 to S22 from the light intensity signal of the measurement light obtained by the photodetector 42.

An optical characteristic element calculation process for calculating the angle of rotation of the measurement sample 50 is performed in steps S24 and S26.

Specifically, the equation (14) is derived from the value of the spectral peak shown by the equation (13), and a series of calculations for calculating the value shown by the equation (15) is performed (steps S24 and S26).

The wavelength characteristics ω(k) (optical characteristic element in a broad sense) of the angle of rotation of the measurement sample 50 can thus be calculated.

When the photodetector 42 includes the light-receiving spectroscopes arranged in rows and columns, the suitability of the characteristics in a predetermined region (e.g. entire region) of the measurement sample 50 can be determined by performing the optical characteristic element calculation process in units of the light-receiving spectroscopes. When a defective portion exists in the measurement sample 50, the position of the defective portion can be accurately specified in addition to the presence or absence of the defective portion.

### 1.5. Other Embodiments

The above embodiment has been described taking an example in which the retardation of the carrier retarder 24 of the optical system 1 is known in advance. However, since the retardation of the carrier retarder 24 can be determined using the measuring apparatus according to this embodiment, the measurement sample may be measured using the determined retardation as the known value.

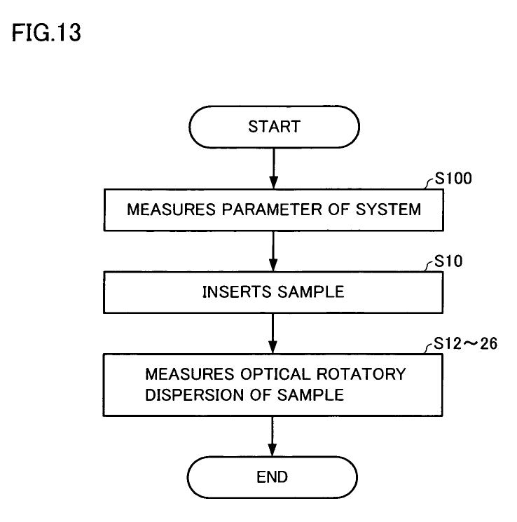

FIG. 13 shows a flowchart of the process according to this embodiment.

The parameter of the carrier retarder 24 is measured in a step S100.

In this case, a sample of which the angle of rotation ω(k) is known is inserted into the optical system 1 shown in FIG. 1 as the measurement sample 50, and a snap-shot measurement is performed in the same manner as in the above embodiment.

In this case, the value of the angle of rotation ω(k) shown by the equation (15) is given in advance. The value shown by the equation (14) is determined by measurement. Therefore, the retardation δ(k) of the carrier retarder 24 shown by the equation (15) can be calculated from these values.

Alternatively, the measurement may be performed in the same manner as in the above embodiment in a state in which the measurement sample 50 or the measurement sample 50 and the quarter-wave plate 25 are not inserted into the optical system 1 shown in FIG. 1, for example.

The retardation δ(k) of the carrier retarder 24 can also be calculated from the measured values thus obtained.

The wavelength characteristics δ(k) of the retardation thus determined are stored in a storage means of the calculation device 60 as the known value, whereby the optical rotatory dispersion of the measurement sample 50 can be determined in the steps S10 to S26 in the same manner as in the above embodiment.

### 1.6. Verification Experiment

A verification experiment for confirming the effectiveness of the optical characteristic measuring apparatus (optical characteristic measuring method) was conducted. The results are given below.

In the verification experiment, optical activity standard samples (sample A and sample B) formed of a rock crystal were used as the measurement sample 50. The samples (sample A and sample B) had an angle of rotation of 8.65° (sample A) and 34.11° (sample B) at a wavelength of 589.3 nm.

In the experiment, a 7λ retardation plate was used as the carrier retarder 24.

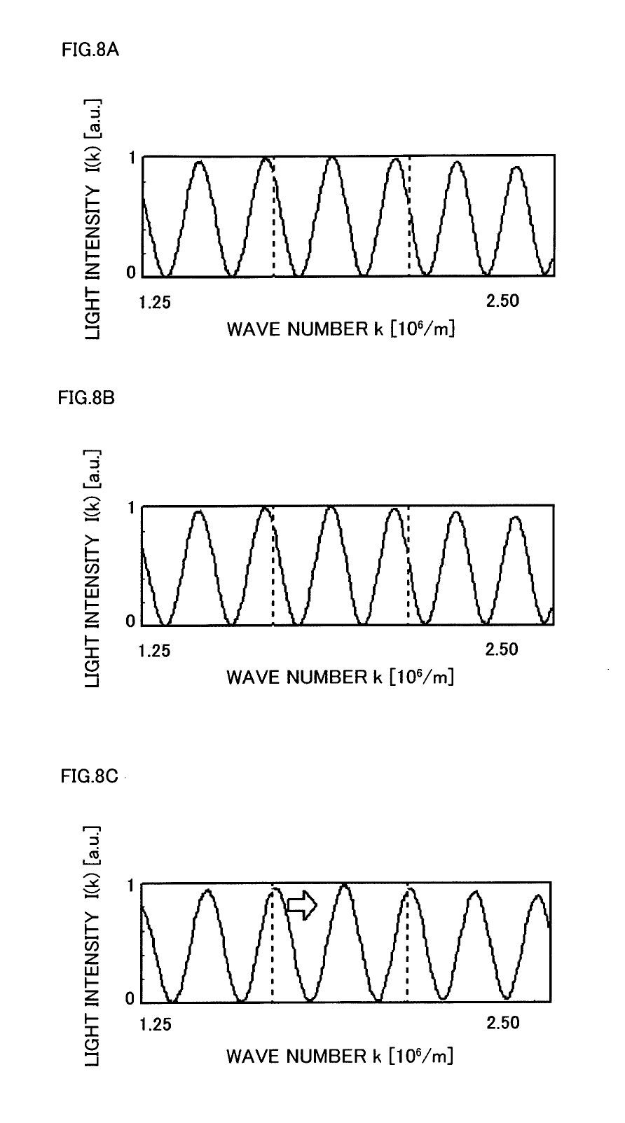

FIG. 8 show the light intensity I(k) detected by the photodetector 42.

FIGS. 8A, 8B, and 8C respectively show the light intensity distribution before the sample was inserted, the light intensity distribution when the sample A was inserted, and the light intensity distribution when the sample B was inserted. In FIGS. 8B and 8C, the light intensity I(k) is shifted in an arrow direction as compared with FIG. 8A. This indicates that the light passing through the optical system was affected by the optical rotatory dispersion of the measurement sample 50.

The light intensity I(k) was subjected to Fourier analysis to detect the phase.

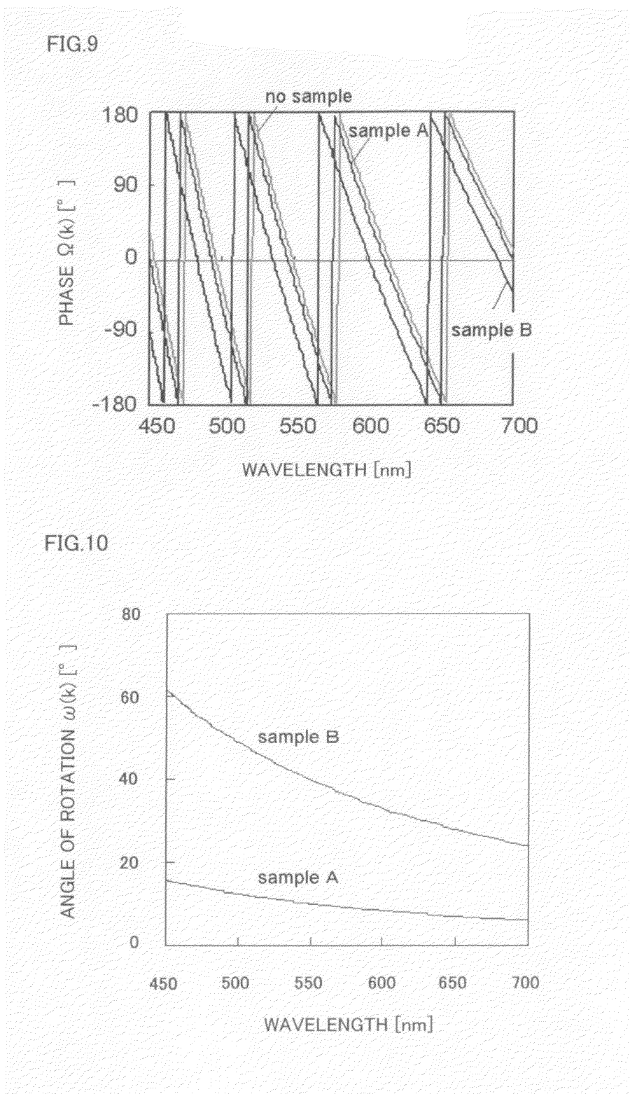

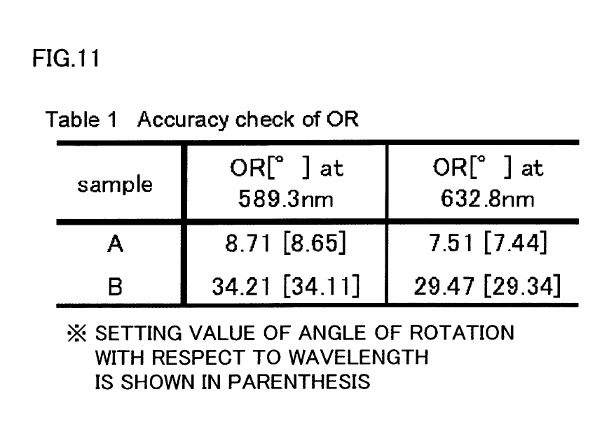

FIG. 9 shows the wavelength distribution of the composite phase Q shown by the equation (9). Different phases were observed when the sample was not inserted, when the sample A was inserted, and when the sample B was inserted. The optical rotatory dispersion characteristics of the sample A and the sample B shown in FIG. 10 were obtained by unwrapping the phase with respect to the wavelength and utilizing the equation (15). A table shown in FIG. 11 shows a comparison between the design values and the measured values of the optical activity standard samples (measurement sample 50). The results shown in FIG. 11 confirmed that the angle of rotation could be measured with an accuracy of about 0.1°. The above results confirm the effectiveness of the measurement method according to the invention.

### 1.7. The Invention is not Limited to the Above Embodiments and Various Modifications and Variations are Possible without Departing from the Spirit and Scope of the Invention

For example, the optical characteristic measuring apparatus may be configured to measure the optical characteristics of a sample which reflects light as the measurement sample 50. In this case, the optical system may be configured so that light emitted from the light source 12 is incident on the measurement sample 50 through the polarizer 22, the carrier retarder 24, and the quarter-wave plate 25, and the light reflected by the measurement sample 50 (light modulated by the measurement sample 50) is incident on the photodetector 42 through the analyzer 34. The optical characteristic measuring apparatus may be configured to calculate the matrix elements of a matrix (e.g. Mueller matrix or Jones matrix) representing the optical characteristics of the measurement sample 50.

### 2. Second Embodiment

A case of applying the invention to a system which measures the optical rotatory dispersion (optical characteristic element in a broad sense) of a measurement target in one shot using a method differing from that of the above embodiment is described below as a second embodiment. The same members as in the first embodiment are indicated by the same symbols. Detailed description of these members is omitted.

### 2.1. Configuration of Optical Characteristic Measuring Apparatus

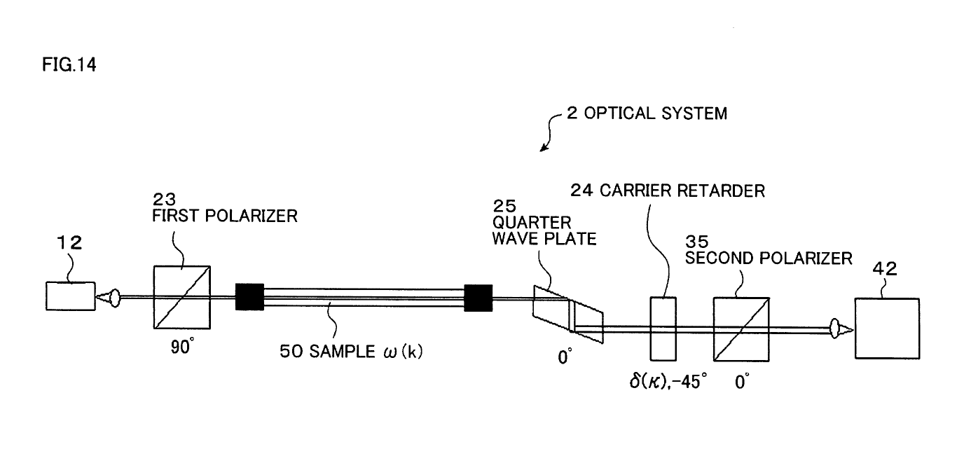

FIG. 14 is a diagram showing the optical arrangement of a measurement sample 50, a first polarizer 23, a quarter-wave plate 25, a carrier retarder 24, and a second polarizer 35 in an optical system 2 according to this embodiment.

As shown in FIG. 14, the optical system 2 includes the first polarizer 23, the measurement sample 50, the quarter-wave plate 25 without wavelength dependence, the carrier retarder 24, and the second polarizer 35 disposed in an optical path 100 connecting a light source 12 and a photodetector 42. The first polarizer 23 and the second polarizer 35 may make a pair. In this case, the first polarizer 23 may be referred to as a polarizer, and the second polarizer 35 may be referred to as an analyzer. In FIG. 14, light guides 14 and 40 are omitted. The optical system 2 may or may not include the light guides 14 and 40.

In the optical system 2, the first polarizer 23 (polarizer) is an incident-side polarizer which linearly polarizes light emitted from the light source 12. The second polarizer 35 (analyzer) is an exit-side polarizer which makes a pair with the first polarizer 23 and linearly polarizes light which has passed through the carrier retarder 24.

Disposing the quarter-wave plate 25, the carrier retarder 24, and the second polarizer 35 to have such an optical positional relationship allows the polarization plane of light which has passed through the quarter-wave plate 25, the carrier retarder 24, and the second polarizer 35 to change depending on the wavelength. The details are described later.

In the optical system 2, the carrier retarder 24 may be set so that its principal axis direction differs from the principal axis direction of the second polarizer 35 (analyzer) by 45° either clockwise or counterclockwise. The quarter-wave plate 25 may be set so that its principal axis direction differs from the principal axis direction of the carrier retarder 24 by 45° either clockwise or counterclockwise. The quarter-wave plate 25 may be set so that its principal axis direction differs from the principal axis direction of the second polarizer 35 by 0° or 90° either clockwise or counterclockwise. This enables a highly accurate measurement.

The first polarizer 23 (polarizer) may be set so that its principal axis direction differs from the principal axis direction of the second polarizer 35 (analyzer) by 0° or 90° either clockwise or counterclockwise. This enables utilization of a simple calculation equation. Note that the angular difference in principal axis direction between the first polarizer 23 and the second polarizer 35 may be arbitrarily set.

In the example shown in FIG. 14, when the principal axis direction of the second polarizer 35 is 0°, the principal axis directions of the carrier retarder 24, the quarter-wave plate 25, and the first polarizer 23 are rotated clockwise by −45°, 0°, and 90°, respectively.

### 2.2. Optical Characteristic Measurement Principle

The principle of the optical characteristic measuring apparatus according to this embodiment is described below.

### 2.2.1. White Light Modulation Principle Using Optical System 2

White light emitted from the light source 12 passes through the first polarizer 23, as shown in FIG. 14. This causes the white light to be linearly polarized.

The white light which has passed through the first polarizer 23 passes through the measurement sample 50. The polarization plane of the linearly polarized white light changes depending on the wavelength due to the effects of the optical activity of the measurement sample 50.

The light which has passed through the measurement sample 50 passes through the quarter-wave plate 25 and the carrier retarder 24. The polarization plane of the linearly polarized light emitted from the measurement sample 50 is modulated depending on the wavelength (λ1, λ2, . . . , and λn) by the quarter-wave plate 25 and the carrier retarder 24 (see FIG. 5).

The spectroscopic polarization-modulated polarization state is detected by the second polarizer 35 and the photoreceiver 42 as the light intensity (see FIG. 6).

The optical system 2 shown in FIG. 14 causes the white light to be modulated as described above. Since the modulated light is detected as the light intensity, the light which has passed through the optical system 2 contains information relating to the angle of rotation of the measurement sample 50.

### 2.2.2. Mueller Matrix of Optical System 2 and Optical Characteristic Measurement Principle Using the Same

The Mueller matrices of the optical system 2 are expressed as follows.

An equation (2-1) indicates the Stokes parameter Sᵢₙ of incident light. Equations (2-2) to (2-6) respectively indicate the Mueller matrices of the elements forming the optical system 2, i.e., the second polarizer 35 (analyzer), the carrier retarder 24, the quarter-wave plate 25, the measurement sample 50, and the first polarizer 23 (polarizer).

$$\begin{matrix}{S}_{i n} = [ \begin{matrix}{s}_{0} \\ {s}_{1} \\ {s}_{2} \\ {s}_{3}\end{matrix} ] = [ \begin{matrix}1 \\ 0 \\ 0 \\ 0\end{matrix} ] & ( 2 \text{-} 1 ) \\ {P}_{0 °} = \frac{1}{2} [ \begin{matrix}1 & 1 & 0 & 0 \\ 1 & 1 & 0 & 0 \\ 0 & 0 & 0 & 0 \\ 0 & 0 & 0 & 0\end{matrix} ] & ( 2 \text{-} 2 ) \\ {R}_{δ ( k ) , - 45 °} = [ \begin{matrix}1 & 0 & 0 & 0 \\ 0 & cos δ ( k ) & 0 & sin δ ( k ) \\ 0 & 0 & 1 & 0 \\ 0 & - sin δ ( k ) & 0 & cos δ ( k )\end{matrix} ] & ( 2 \text{-} 3 ) \\ {FR}_{0 °} = [ \begin{matrix}1 & 0 & 0 & 0 \\ 0 & 1 & 0 & 0 \\ 0 & 0 & 0 & 1 \\ 0 & 0 & - 1 & 0\end{matrix} ] & ( 2 \text{-} 4 ) \\ {T}_{ω ( k )} = [ \begin{matrix}1 & 0 & 0 & 0 \\ 0 & cos 2 ω ( k ) & - sin 2 ω ( k ) & 0 \\ 0 & sin 2 ω ( k ) & cos 2 ω ( k ) & 0 \\ 0 & 0 & 0 & 1\end{matrix} ] & ( 2 \text{-} 5 ) \\ {A}_{90 °} = \frac{1}{2} [ \begin{matrix}1 & - 1 & 0 & 0 \\ - 1 & 1 & 0 & 0 \\ 0 & 0 & 0 & 0 \\ 0 & 0 & 0 & 0\end{matrix} ] & ( 2 \text{-} 6 )\end{matrix}$$

where, δ(k) indicates the retardation of the carrier retarder 24, and ω(k) indicates the angle of rotation of the optically active substance which is the measurement sample 50.

The relationship between each Mueller matrix and the Stokes parameter is given by the following equation.

Sₒᵤₜ=P_{0°}R_{δ(k),-″°}·FR_{0°}·T_{ω(k)}·A_{90°}·Sᵢₙ (2-7)

Therefore, the light intensity obtained by the photodetector 42 is expressed as follows.

$$\begin{matrix}I ( k ) = \frac{{I}_{0}}{4} ( 1 - cos ( Ω ( k ) ) ) & ( 2 \text{-} 8 ) \\ Ω ( k ) = δ ( k ) + 2 ϕ ( k ) & ( 2 \text{-} 9 )\end{matrix}$$

where, I₀ indicates the maximum light intensity, and Ω(k) indicates the composite phase due to the retardation of the carrier retarder 24 and the angle of rotation of the measurement sample 50 (optically active substance).

The equations (2-8) and (2-9) respectively correspond to the equations (8) and (9) described in the first embodiment. Therefore, when utilizing the optical system 2 according to this embodiment, the angle of rotation Ω(k) of the measurement sample 50 can be calculated according to the process described in the first embodiment. Note that description of the subsequent process is omitted for convenience.

As described above, when utilizing the optical characteristic measuring apparatus including the optical system 2 shown in FIG. 14, the angle of rotation ω(k) of the measurement sample 50 can be calculated in the same manner as in the first embodiment. Therefore, this embodiment enables the optical rotatory dispersion of the measurement sample 50 to be determined utilizing a device which does not require special electrical/mechanical control.

### 2.3. This Embodiment is not Limited to the Above Configuration, and Various Modifications and Variations May be Made.

For example, the optical characteristic measuring apparatus may be configured to measure the optical characteristics of a sample which reflects light as the measurement sample 50. In this case, the optical system may be configured so that light emitted from the light source 12 is incident on the measurement sample 50 through the first polarizer 23, and the light reflected by the measurement sample 50 (light modulated by the measurement sample 50) is incident on the photodetector 42 through the quarter-wave plate 25, the carrier retarder 24, and the second polarizer 35.

### 3. Third Embodiment

A case of applying the invention to a system which can simultaneously measure the optical rotatory dispersion, the birefringence dispersion, and the principal axis direction of the measurement sample 50 is described below.

The same members as in the first embodiment are indicated by the same symbols. Detailed description of these members is omitted.

### 3.1. Measurement Target According to this Embodiment

The measurement sample 50 as the measurement target according to this embodiment is described below.

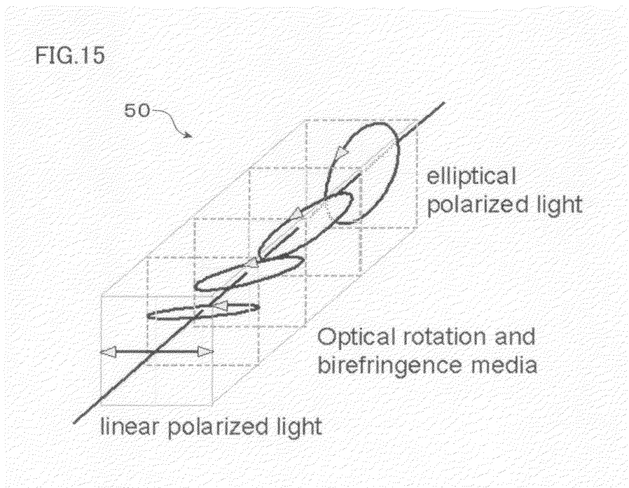

As shown in FIG. 15, the polarization state of light incident on a substance which simultaneously shows optical rotation and birefringence (e.g. rock crystal or twisted nematic liquid crystal) changes so that the polarization plane is rotated while the ellipticity increases.

The ellipticity increases due to birefringence, and the polarization plane is rotated due to optical rotation.

Such a phenomenon may be considered to be a model of a composite component of a retardation plate and an optical rotator. Specifically, the Mueller matrix of the composite component is obtained by multiplying the Mueller matrix of the optical element which causes birefringence by the Mueller matrix of the optical rotator.

The Mueller matrix equation BT_{Δ(k),φ,ω(k)} of the optical rotation/birefringence composite component is expressed as follows.

BT_{Δ(k),φ,ω(k)}=T_{ω(k)}·B_{Δ(k),φ} (16)

The Mueller matrix of a sample having a retardation of Δ(k) and the principal axis direction of φ is expressed as follows.

$${B}_{Δ ( k ) , φ} = [ \begin{matrix}1 & 0 & 0 & 0 \\ 0 & 1 + ( - 1 + cos Δ ( k ) ) {sin}^{2} 2 φ & {sin}^{2} \frac{Δ ( k )}{2} sin 4 φ & - sin Δ ( k ) sin 2 φ \\ 0 & {sin}^{2} \frac{Δ ( k )}{2} sin 4 φ & 1 + ( - 1 + cos Δ ( k ) ) {cos}^{2} 2 φ & sin Δ ( k ) cos 2 φ \\ 0 & sin Δ ( k ) sin 2 φ & - sin Δ ( k ) cos 2 φ & cos Δ ( k )\end{matrix} ] \qquad ( 17 )$$

The Mueller matrix of the optical rotation/birefringence composite component is expressed as follows by calculating the equation (16).

$${BT}_{Δ ( k ) , φ , ω ( k )} = [ \begin{matrix}{m}_{00} & {m}_{01} & {m}_{02} & {m}_{03} \\ {m}_{10} & {m}_{11} & {m}_{12} & {m}_{13} \\ {m}_{20} & {m}_{21} & {m}_{22} & {m}_{23} \\ {m}_{30} & {m}_{31} & {m}_{32} & {m}_{33}\end{matrix} ] \qquad ( 18 )$$

Each component of the Mueller matrix is expressed as follows.

$$\begin{matrix} {m}_{00} = 1 , {m}_{01} = 0 , {m}_{02} = 0 , {m}_{03} = 0 & ( 19 - 1 ) \\ {m}_{10} = 0 & ( 19 - 2 ) \\ {m}_{11} = cos 2 ω ( k ) ( 1 - 2 {sin}^{2} \frac{Δ ( k )}{2} {sin}^{2} 2 φ ) - sin 2 ω ( k ) {sin}^{2} \frac{Δ ( k )}{2} sin 4 φ & ( 19 - 3 ) \\ {m}_{12} = - sin 2 ω ( k ) ( 1 - 2 {sin}^{2} \frac{Δ ( k )}{2} {sin}^{2} 2 φ ) + cos 2 ω ( k ) {sin}^{2} \frac{Δ ( k )}{2} sin 4 φ & ( 19 - 4 ) \\ {m}_{13} = - sin Δ ( k ) sin 2 ( φ + ω ( k ) ) & ( 19 - 5 ) \\ {m}_{20} = 0 & ( 19 - 6 ) \\ {m}_{21} = sin 2 ω ( k ) ( 1 - 2 {sin}^{2} \frac{Δ ( k )}{2} {sin}^{2} 2 φ ) + cos 2 ω ( k ) {sin}^{2} \frac{Δ ( k )}{2} sin 4 φ & ( 19 - 7 ) \\ {m}_{22} = cos 2 ω ( k ) ( 1 - 2 {sin}^{2} \frac{Δ ( k )}{2} {sin}^{2} 2 φ ) + sin 2 ω ( k ) {sin}^{2} \frac{Δ ( k )}{2} sin 4 φ & ( 19 - 8 ) \\ {m}_{23} = sin Δ ( k ) cos 2 ( φ + ω ( k ) ) & ( 19 - 9 ) \\ {m}_{30} = 0 & ( 19 - 10 ) \\ {m}_{31} = sin Δ ( k ) sin 2 ω ( k ) & ( 19 - 11 ) \\ {m}_{32} = - sin Δ ( k ) cos 2 ω ( k ) & ( 19 - 12 ) \\ {m}_{33} = cos Δ ( k ) & ( 19 - 13 )\end{matrix}$$

### 3.2. Configuration of Optical Characteristic Measuring Apparatus

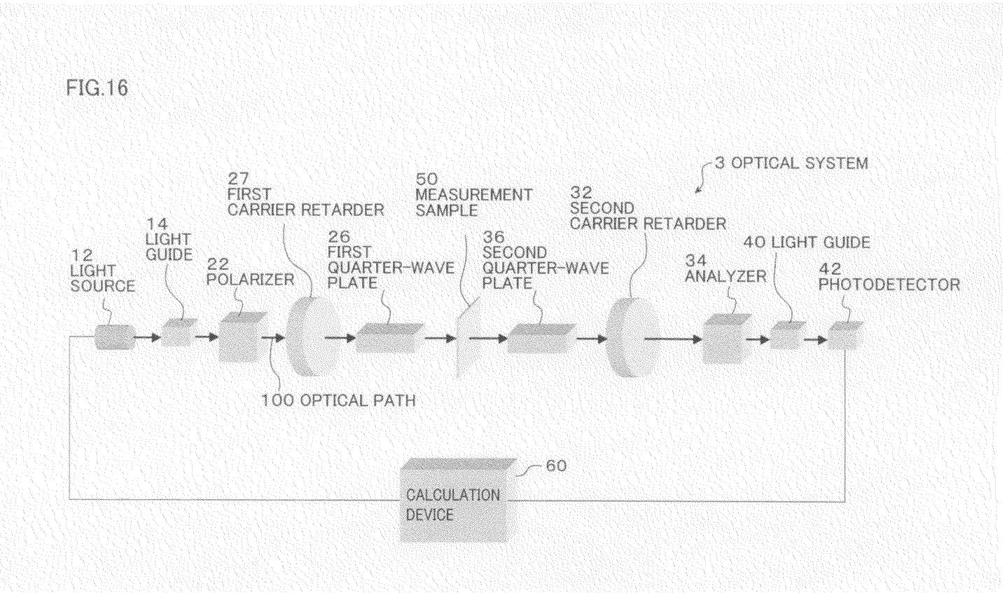

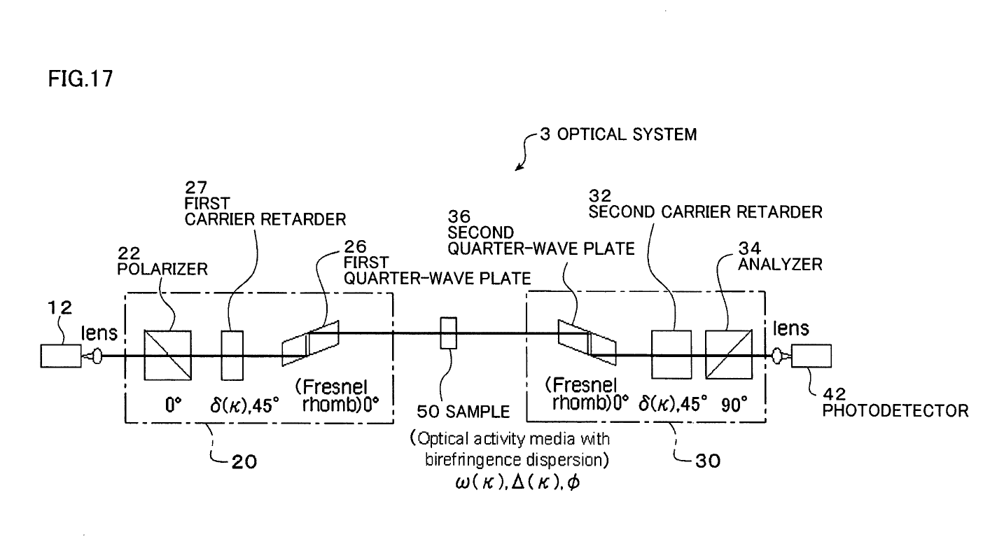

FIGS. 16 and 17 are diagrams illustrative of an optical characteristic measuring apparatus according to this embodiment.

The optical characteristic measuring apparatus according to this embodiment includes an optical system 3 and a calculation device 60.

### 3.2.1. Optical System 3

The optical system 3 includes a light source 12 and a photodetector 42.

The optical system 3 further includes a light guide 14, a polarizer 22, a first carrier retarder 27, a first quarter-wave plate 26 without wavelength dependence, the measurement sample 50 as the measurement target, a second quarter-wave plate 36 without wavelength dependence, a second carrier retarder 32, an analyzer 34, and a light guide 40 disposed in an optical path 100 connecting the light source 12 and the photodetector 42.

The first carrier retarder 27 makes a pair with the second carrier retarder 32. The first and second carrier retarders 27 and 32 are disposed in the optical path 100 on the upstream side and the downstream side of the measurement sample 50, respectively.

In this embodiment, the retardations of the first and second carrier retarders 27 and 32 differ depending on the wavelength of light passing through the first and second carrier retarders 27 and 32. Therefore, the polarization state of light which passes through the first and second carrier retarders 27 and 32 changes depending on the wavelength.

The first and second carrier retarders 27 and 32 may be formed using high-order retardation plates, for example. The retardations of the first and second carrier retarders 27 and 32 are known and differ from each other. Specifically, when the retardation of the first carrier retarder 27 is δ₁=αδ and the retardation of the second carrier retarder 32 is δ₂=βδ, α and β are set to be different values.

The first and second quarter-wave plates 26 and 36 make a pair and are disposed in the optical path 100 on the upstream side and the downstream side of the measurement sample 50.

As the first and second quarter-wave plates 26 and 36, various types of quarter-wave plates without wavelength dependence may be arbitrarily used in the same manner as in the first embodiment. In this embodiment, Fresnel rhombs are used as the first and second quarter-wave plates 26 and 36.

FIG. 17 is a diagram showing the optical arrangement of the measurement sample 50, the polarizer 22, the first carrier retarder 27, the first quarter-wave plate 26, the second quarter-wave plate 36, the second carrier retarder 32, and the analyzer 34 in the optical path 100. Note that the light guides 14 and 40 are omitted for convenience of description.

In this embodiment, the polarizer 22, the first carrier retarder 27, and the first quarter-wave plate 26 positioned on the upstream side of the measurement sample 50 are formed as a modulation unit 20. The principal axis directions of the polarizer 22, the first carrier retarder 27, and the first quarter-wave plate 26 have the same relationship as in the first embodiment.

The second quarter-wave plate 36, the second carrier retarder 32, and the analyzer 34 positioned on the downstream side of the measurement sample 50 are formed as an analysis unit 30.

The second quarter-wave plate 36, the second carrier retarder 32, and the analyzer 34 may satisfy the following relationship.

Specifically, the second carrier retarder 32 may be set so that its principal axis direction differs from the principal axis direction of the analyzer 34 by 45° either clockwise or counterclockwise. The second quarter-wave plate 36 may be set so that its principal axis direction differs from the principal axis direction of the second carrier retarder 32 by 45° either clockwise or counterclockwise. The second quarter-wave plate 36 may be set so that its principal axis direction differs from the principal axis direction of the analyzer 34 by 0° or 90° either clockwise or counterclockwise. This enables a highly accurate measurement.

The second quarter-wave plate 36, the second carrier retarder 32, and the analyzer 34 may have the same relationship as in the second embodiment.

In this embodiment, when the principal axis direction of the analyzer 34 is 90°, the principal axis directions of the second carrier retarder 32 and the second quarter-wave plate 36 are rotated by 45° and 0°, respectively.

The principal axis directions of the modulation unit 20 and the analysis unit 30 are preferably set so that the principal axis direction of the analyzer 34 differs from the principal axis direction of the polarizer 22 by 0° or 90° either clockwise or counterclockwise. In this embodiment, the principal axis direction of the analyzer 34 differs from the principal axis direction of the polarizer 22 by 90°. Note that the angular difference relationship is not limited thereto. The angular difference may be arbitrarily set, if necessary.

The measurement sample 50 is disposed in the optical path 100 between the first and second quarter-wave plates 26 and 36.

### 3.2.2. Photodetector 42

The optical system 3 includes the photodetector 42. Any of the above-described configurations may be applied to the photoreceiver 42. Therefore, description of the photoreceiver 42 is omitted.

### 3.3. Optical Characteristic Measurement Principle

The measurement principle of the optical characteristic measuring apparatus according to this embodiment is described below.

The optical characteristic measuring apparatus according to this embodiment can simultaneously measure the optical rotatory dispersion, the birefringence dispersion, and the principal axis direction of the measurement sample 50.

Almost the same combination as the combination of the polarizer 22, the first carrier retarder 27, and the first quarter-wave plate 26 in the optical characteristic measuring apparatus according to the first embodiment is disposed symmetrically on the downstream side of the measurement sample 50. Specifically, in the optical system 3, optical elements of the same type may be arranged in a mirror image on each side of the measurement sample 50.

In this case, the retardations of the first and second carrier retarders 27 and 32 are respectively referred to as δ₁(k) and δ₂(k).

In this embodiment, the polarization plane of white light emitted from the light source 12 changes depending on the wavelength while passing through the polarizer 22, the first carrier retarder 27, and the first quarter-wave plate 26 without wavelength dependence.

The polarization plane of the light which has passed through the measurement sample 50 further changes while passing through the second quarter-wave plate 36 without wavelength dependence, the second carrier retarder 32, and the analyzer 34.

The light which has passed through the analyzer 34 enters the photodetector 42 as measurement light which is frequency-modulated depending on the wavelength so that the light intensity is detected.

### 3.3.1. Mueller Matrix of Optical System 3 and Optical Characteristic Measurement Principle Using the Same

The Mueller matrices of the optical system 2 are expressed as follows.

The Mueller matrix of each polarizing element and the Stokes parameter {s₀, s₁, s₂, s₃}^{T} of incident light are expressed as follows.

$$\begin{matrix}{S}_{in} = [ \begin{matrix}{\ddot{s}}_{0} \\ {s}_{1} \\ {s}_{2} \\ {s}_{3}\end{matrix} ] = [ \begin{matrix}1 \\ 0 \\ 0 \\ 0\end{matrix} ] & {( 1 )}^{′} \\ {P}_{{0}^{°}} = \frac{1}{2} [ \begin{matrix}1 & 1 & 0 & 0 \\ 1 & 1 & 0 & 0 \\ 0 & 0 & 0 & 0 \\ 0 & 0 & 0 & 0\end{matrix} ] & {( 2 )}^{′} \\ R {1}_{{δ}_{1 ( k ) , 45 °}} = [ \begin{matrix}1 & 0 & 0 & 0 \\ 0 & cos {δ}_{1} ( k ) & 0 & - sin {δ}_{1} ( k ) \\ 0 & 0 & 1 & 0 \\ 0 & sin {δ}_{1} ( k ) & 0 & cos {δ}_{1} ( k )\end{matrix} ] & {( 3 )}^{′} \\ {FR}_{0 °} = [ \begin{matrix}1 & 0 & 0 & 0 \\ 0 & 1 & 0 & 0 \\ 0 & 0 & 1 & 0 \\ 0 & 0 & - 1 & 0\end{matrix} ] & {( 4 )}^{′} \\ R {2}_{{δ}_{2} ( k ) , 45 °} = [ \begin{matrix}1 & 0 & 0 & 0 \\ 0 & cos {δ}_{2} ( k ) & 0 & - sin {δ}_{2} ( k ) \\ 0 & 0 & 1 & 0 \\ 0 & sin {δ}_{2} ( k ) & 0 & cos {δ}_{2} ( k )\end{matrix} ] & {( 5 )}^{′} \\ {A}_{90 °} = \frac{1}{2} [ \begin{matrix}1 & - 1 & 0 & 0 \\ - 1 & 1 & 0 & 0 \\ 0 & 0 & 0 & 0 \\ 0 & 0 & 0 & 0\end{matrix} ] & {( 6 )}^{′}\end{matrix}$$

where, δ₁(k) and δ₂(k) indicate the retardations of the first and second carrier retarders 27 and 32.

The relationship between each Mueller matrix and the Stokes parameter is given by the following equation.

Sₒᵤₜ=A_{90°}·R_{δ}_{₂}_{(k),45°}·FR_{0°}·BT_{Δ(k),φ,ω(k)}·FR_{0°}·R_{δ}_{₁}_{(k),45°}·P_{0°}·Sᵢₙ (7)

where, Sᵢₙ and Sₒᵤₜ respectively indicate the input Stokes parameter and the output Stokes parameter.

The equations (2)′, (3)′, (5)′, and (6)′ indicate the Mueller matrices of the polarizer 22, the first carrier retarder 27, the second carrier retarder 32, and the analyzer 34, respectively.

The equation (4)′ indicates the Mueller matrix of the first and second quarter-wave plates 26 and 36.

The light intensity I(k) is expressed as follows using the Mueller matrices of the optical system shown by the equations (1)′ to (7)′ and the Mueller matrix of the measurement sample 50.

$$I ( k ) = \frac{{I}_{0}}{4} ( \begin{matrix}1 - {cos}^{2} \frac{Δ ( k )}{2} cos [ ( {δ}_{1} ( k ) - {δ}_{2} ( k ) ) + 2 ω ( k ) ] - \\ {sin}^{2} \frac{Δ ( k )}{2} cos [ ( {δ}_{1} ( k ) + {δ}_{2} ( k ) ) + 2 ( 2 φ + ω ( k ) ) ]\end{matrix} ) \qquad ( 20 )$$

The equation (20) contains information relating to the angle of rotation ω(k) and the retardation Δ(k) of the measurement sample 50 in a given wavelength band (wave number k) and information relating to the principal axis direction φ of the measurement sample 50.

This equation is substituted as follows.

$$\begin{matrix}I ( k ) = bias + {amp}_{{δ}_{1} - {δ}_{2}} ( k ) \cdot cos ( {phase}_{{δ}_{1} - {δ}_{2}} ( k ) ) + {amp}_{{δ}_{1} + {δ}_{2}} ( k ) \cdot cos ( {phase}_{{δ}_{1} + {δ}_{2}} ( k ) ) \\ where , \\ bias = \frac{{I}_{0}}{4} & ( 20 - 1 ) \\ {amp}_{{δ}_{1} - {δ}_{2}} ( k ) = - \frac{{I}_{0}}{4} {cos}^{2} \frac{Δ ( k )}{2} & ( 21 ) \\ {phase}_{{δ}_{1} - {δ}_{2}} ( k ) = ( {δ}_{1} ( k ) - {δ}_{2} ( k ) ) + 2 ω ( k ) & ( 22 ) \\ {amp}_{{δ}_{1} + {δ}_{2}} ( k ) = - \frac{{I}_{0}}{4} {sin}^{2} \frac{Δ ( k )}{2} & ( 23 ) \\ {phase}_{{δ}_{1} - {δ}_{2}} ( k ) = ( {δ}_{1} ( k ) + {δ}_{2} ( k ) ) + 2 ( 2 φ + ω ( k ) ) & ( 24 )\end{matrix}$$

These equations indicate that the light intensity is modulated by the frequencies (δ₁(k)−δ₂(k)) and (δ₁(k)+δ₂(k)).

Therefore, the angle of rotation ω(k), the wavelength dependence Δ(k) of the retardation, and the principal axis direction φ of the measurement sample 50 can be separately measured by detecting the amplitude component and the phase component using a Fourier transform method.

Solving the equation (20-1) using Euler's formula yields the following equation.

$$\begin{matrix}I ( k ) = bias + {c}_{{δ}_{1} - {δ}_{2}} ( k ) + {c}_{{δ}_{1} - {δ}_{2}}^{*} ( k ) + {c}_{{δ}_{1} + {δ}_{2}} ( k ) + {c}_{{δ}_{1} + {δ}_{2}}^{*} ( k ) \\ where , \\ {c}_{{δ}_{1} - {δ}_{2}} ( k ) = \frac{1}{2} {amp}_{{δ}_{1} - {δ}_{2}} ( k ) \cdot exp ( i ( {phase}_{{δ}_{1} - {δ}_{2}} ( k ) ) ) & ( 24 - 1 ) \\ {c}_{{δ}_{1} + {δ}_{2}} ( k ) = \frac{1}{2} {amp}_{{δ}_{1} + {δ}_{2}} ( k ) \cdot exp ( i ( {phase}_{{δ}_{1} + {δ}_{2}} ( k ) ) ) & ( 24 - 2 )\end{matrix}$$

and c_{δ1-δ2}(k) and c_{δ1+δ2}(k) respectively indicate conjugate components of c*_{δ1+δ2}(k) and c*_{δ1+δ2}(k).

Subjecting the equation (24-1) to inverse Fourier transformation with respect to the wave number k yields the following equation.

F⁻¹[I(k)]Ĩ(v)=Bias+C_{δ}_{₁}_{-δ}_{₂}(v)+C*_{δ}_{₁}_{-δ}_{₂}(v)+C_{δ}_{₁}_{+δ}_{₂}(v)+C*_{δ}_{₁}_{+δ}_{₂}(v) (24-3)

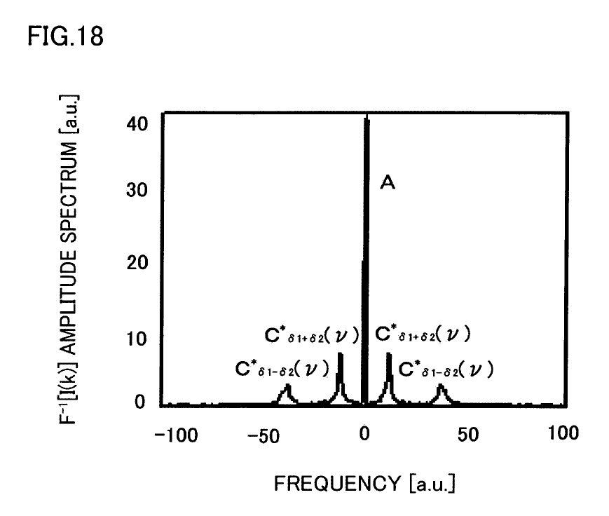

FIG. 18 shows the Fourier spectrum shown by the equation (24-3). In FIG. 18, the horizontal axis indicates the frequency, and the vertical axis indicates the amplitude spectrum.

As shown in FIG. 18, in the Fourier spectrum obtained by subjecting the light intensity I(k) to inverse Fourier transformation with respect to the wave number k, a spectral peak of the direct-current component appears in the region in which the frequency is 0, and two spectral peaks C_{δ1-δ2}(v) and C_{δ1+δ2}(v) respectively appear at the frequencies (δ₁(v)−δ₂(v)) and (δ₁(v)+δ₂(v)).

### 3.3.2. Utilization of Measured Values

In this embodiment, the light intensity signal I(k) detected by the photodetector 42 is used for calculations as described below.

Specifically, the light intensity signal I(k) shown by the equation (24-1) is subjected to inverse Fourier transformation (analysis process in a broad sense) with respect to the wave number k to obtain a Fourier spectrum (frequency spectrum). The two spectral peaks C_{α-β}(v) and C_{α+β}(v) are extracted from the Fourier spectrum, and subjected to Fourier analysis to determine the following values as measured values.

F└C_{δ}_{₁}_{-δ}_{₂}(v)┘=c_{δ}_{₁}_{-δ}_{₂}(k)

F└C_{δ}_{₁}_{+δ}_{₂}(v)┘=c_{δ}_{₁}_{+δ}_{₂}(k) (24-4)

Specifically, the values of the equation (24-4) can be determined as measured values from the light intensity signal I(k) detected by the photodetector 42.

The spectral peaks can be extracted by filtering.

### 3.3.3. Calculation of Angle of Rotation ω(K), Retardation Δ(K), and Principal Axis Direction φ of Measurement Sample 50 Using Measured Values

The equation (24-4) is expressed by the following equation utilizing the equation (24-4).

$$F [ {C}_{{δ}_{1} - {δ}_{2}} ( v ) ] = {c}_{{δ}_{1} - {δ}_{2}} ( k ) = \frac{1}{2} {amp}_{{δ}_{1} - {δ}_{2}} ( k ) \cdot exp ( i ( {phase}_{{δ}_{1} - {δ}_{2}} ( k ) ) ) \\ F [ {C}_{{δ}_{1} + {δ}_{2}} ( v ) ] = {c}_{{δ}_{1} + {δ}_{2}} ( k ) = \frac{1}{2} {amp}_{{δ}_{1} + {δ}_{2}} ( k ) \cdot exp ( i ( {phase}_{{δ}_{1} + {δ}_{2}} ( k ) ) ) \qquad ( 24 - 5 )$$

amp_{δ1-δ2}(k), phase_{δ1-δ2}(k), amp_{δ1+δ2}(k), and phase_{δ1+δ2}(k) are expressed as follows from the equation (24-5) based on the real number component Re and the imaginary number component Im of each spectral peak and the retardations δ₁(k) and δ₂(k) of the first and second carrier retarders 27 and 32.

$${amp}_{{δ}_{1} - {δ}_{2}} ( k ) = \sqrt{Re [ {{c}_{{δ}_{1} … {δ}_{2}} ( k )}^{2} ] + {Im [ {c}_{{δ}_{1} - {δ}_{2}} ( k ) ]}^{2}} \\ {phase}_{{δ}_{1} - {δ}_{2}} ( k ) = {tan}^{- 1} \frac{Im [ {c}_{{δ}_{1} - {δ}_{2}} ( k ) ]}{Re [ {c}_{{δ}_{1} - {δ}_{2}} ( k ) ]} \\ {amp}_{{δ}_{1} + {δ}_{2}} ( k ) = \sqrt{{Re [ {c}_{{δ}_{1} + {δ}_{2}} ( k ) ]}^{2} + {Im [ {c}_{{δ}_{1} + {δ}_{2}} ( k ) ]}^{2}} \\ {phase}_{{δ}_{1} + {δ}_{2}} ( k ) = {tan}^{- 1} \frac{Im [ {c}_{{δ}_{1} + {δ}_{2}} ( k ) ]}{Re [ {c}_{{δ}_{1} + {δ}_{2}} ( k ) ]} \qquad ( 24 - 6 )$$

The optical rotatory dispersion ω(k), the retardation Δ(k), and the principal axis direction φ of the measurement sample 50 are expressed by the following calculation equations from the equations (21) to (24).

$$\begin{matrix}ω ( k ) = \frac{1}{2} ( {phase}_{{δ}_{1} - {δ}_{2}} ( k ) - ( {δ}_{1} ( k ) - {δ}_{2} ( k ) ) ) & ( 25 ) \\ Δ ( k ) = 2 \cdot {tan}^{- 1} \sqrt{\frac{{amp}_{{δ}_{1} + {δ}_{2}} ( k )}{{amp}_{{δ}_{1} - {δ}_{2}} ( k )}} & ( 26 ) \\ φ = - \frac{1}{4} ( {phase}_{{δ}_{1} + {δ}_{2}} ( k ) - ( {δ}_{1} ( k ) + {δ}_{2} ( k ) + 2 ω ( k ) ) ) & ( 27 )\end{matrix}$$

The optical rotatory dispersion ω(k), the retardation Δ(k), and the principal axis direction φ of the measurement sample 50 can be calculated by substituting each value obtained by the equation (24-6) in the equations (25) to (27).

In this embodiment, when the retardations of the first and second carrier retarders 27 and 32 are δ₁=αδ and δ₂=βδ, the retardations of the first and second carrier retarders 27 and 32 are preferably set so that the ratio of (α+β) and (α−β) is two or more or ½ or less. This enables the difference in frequency between the two spectral peaks to be sufficiently increased in the Fourier spectrum shown in FIG. 18. This makes it possible to more accurately measure the birefringence characteristics of the measurement sample 50.

### 3.4. Optical Characteristic Measurement Process

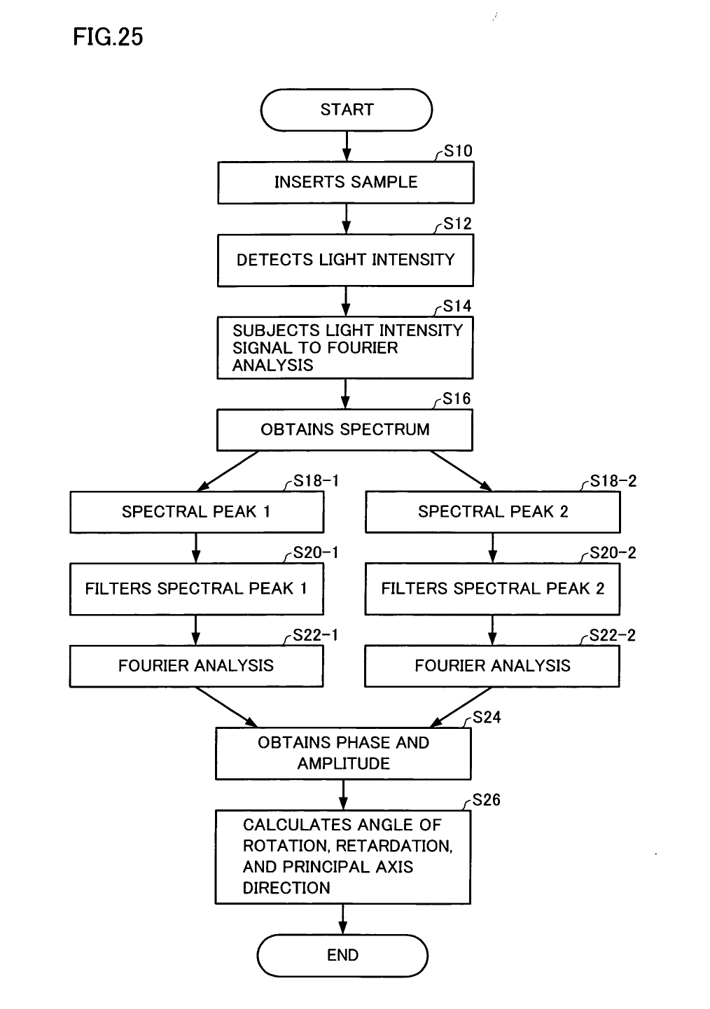

An optical characteristic measurement process employed for the optical characteristic measuring apparatus according to the embodiment is described below. FIG. 25 is a flowchart showing the optical characteristic measurement process.

The measurement sample 50 is inserted into the optical path 100 of the optical system 3 (step S10).

Light is emitted from the light source 12 and caused to pass through the measurement sample 50. The light which has passed through the measurement sample 50 is received by the photodetector 42 to detect the light intensity (step S12).

The light intensity signal is then subjected to Fourier transformation (inverse Fourier transformation) with respect to the wave number k as shown by the equation (24-3) (step S14) to obtain a spectrum (Fourier spectrum or frequency spectrum) (step S16). As shown in FIG. 18, the Fourier spectrum thus obtained contains two spectral peaks C_{δ1-δ2}(v) and C_{δ1+δ2}(v) reflecting the retardations δ₁(k) and δ₂(k) specific to the first and second carrier retarders 27 and 32.

In the subsequent steps S18-1, S18-2, S20-1, and S20-2, the spectral peaks C_{δ1-δ2}(v) and C_{δ1+δ2}(v) are extracted from the Fourier spectrum by filtering.

In the subsequent steps S22-1 and S22-2, the spectral peaks C_{δ1-δ2}(v) and C_{δ1+δ2}(v) thus extracted are subjected to Fourier analysis (e.g. FFT) based on the equation (24-4).

As described above, the spectrum extraction process is performed in the steps S12 to S22 in which the two spectral peaks are extracted from the light intensity signal of the measurement light obtained by the photodetector 42.

In this embodiment, a birefringence characteristic calculation process for calculating the optical activity characteristics and the birefringence characteristics (optical characteristic elements in a broad sense) of the measurement sample 50 is performed in steps S24 and S26.

Specifically, the equation (24-5) is derived from the values of the spectral peak shown by the equation (244) (each value indicating the properties of the spectral peak) and the equation (24-2), and a series of calculations shown by the equations (24-6) to (27) is performed (steps S24 and S26).

The angle of rotation, the wavelength characteristics ω(k) and Δ(k) of the retardation, and the principal axis direction φ of the measurement sample 50 can thus be calculated.

When the photodetector 42 includes the light-receiving spectroscopes arranged in rows and columns, the suitability of the characteristics in a predetermined region (e.g. entire region) of the measurement sample 50 can be determined by performing the optical characteristic element calculation process in units of the light-receiving spectroscopes. When a defective portion exists in the measurement sample 50, the position of the defective portion can be accurately specified in addition to the presence or absence of the defective portion.

### 3.5. Other Embodiments

The above embodiment has been described taking an example in which the retardations of the first and second carrier retarders 27 and 32 of the optical system 3 are known in advance. Note that the invention is not limited thereto. The invention may also be implemented even if the retardations of the first and second carrier retarders 27 and 32 are unknown.

A specific method is the same as in the first embodiment. Therefore, description thereof is omitted.

### 3.6. Verification Experiment

The optical rotatory dispersion, the birefringence dispersion, and the principal axis direction were simultaneously measured.

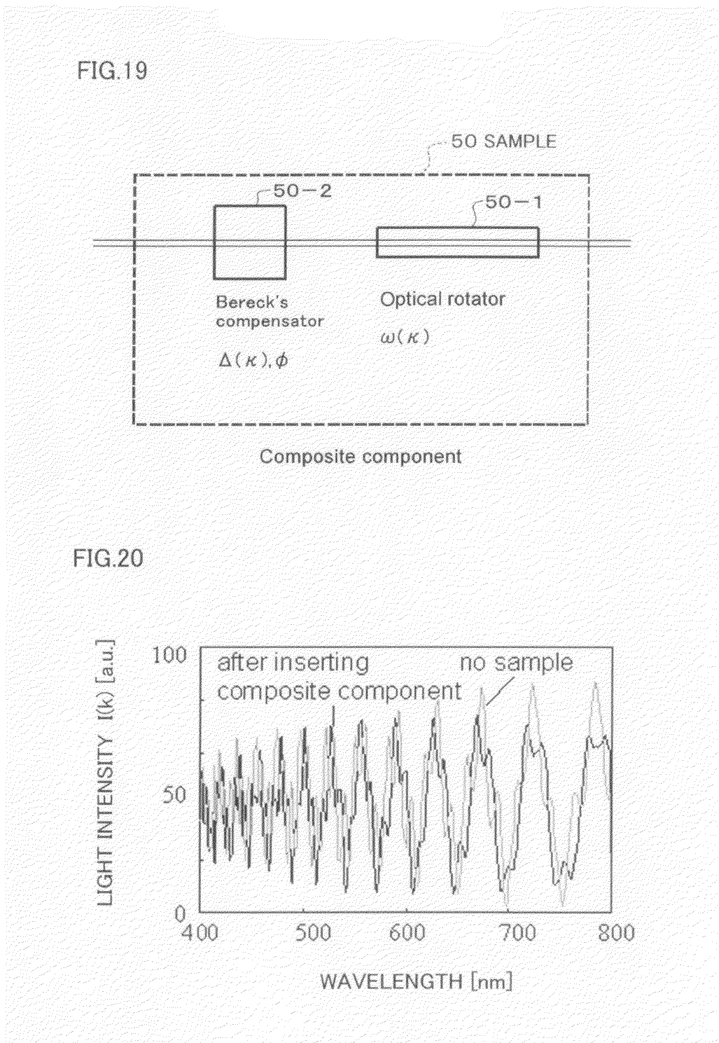

As shown in FIG. 19, a composite component was formed as the measurement sample 50 which shows optical rotatory dispersion and birefringence dispersion by combining an optical activity standard sample 50-1 formed of a rock crystal with a Bereck's compensator 50-2. The Bereck's compensator refers to an optical element of which the retardation and the principal axis direction can be manually set.

An optical rotator (sample A) with an angle of rotation of 8.65° was used as the optical activity standard sample 50-1.

In the experiment, the principal axis direction of the Bereck's compensator 50-2 was rotated to simultaneously detect the optical rotatory dispersion, the birefringence dispersion, and the principal axis direction at −30°, 45°, and 60°.

A 14λ retardation plate and a 30% retardation plate formed of rock crystal plates were used as the first and second retarders.

FIG. 20 shows the light intensity distributions obtained by the photodetector 42 before and after inserting the composite component 50. As shown in FIG. 20, the transmitted light was modulated by different frequencies.

It was confirmed that a change in phase occurred due to the effects of the optical rotatory dispersion and the principal axis direction by inserting the composite component 50.

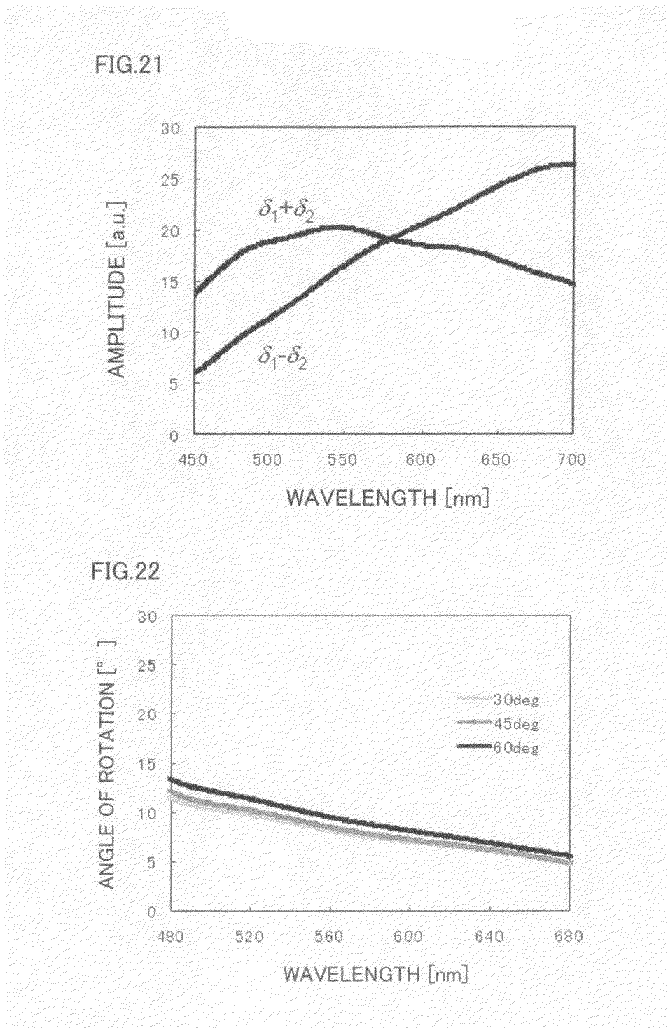

FIG. 21 shows the amplitude components of the frequencies δ₁-δ₂ and δ₁+δ₂ shown by the equations (21) to (23) when subjecting the change in light intensity to Fourier analysis using the algorithm described relating to the principle.

FIGS. 22, 23, and 24 respectively show the wavelength characteristics of the optical rotatory dispersion, the birefringence dispersion, and the principal axis direction of the composite component 50. The following items were confirmed from the characteristic data shown in FIGS. 22, 23, and 24.

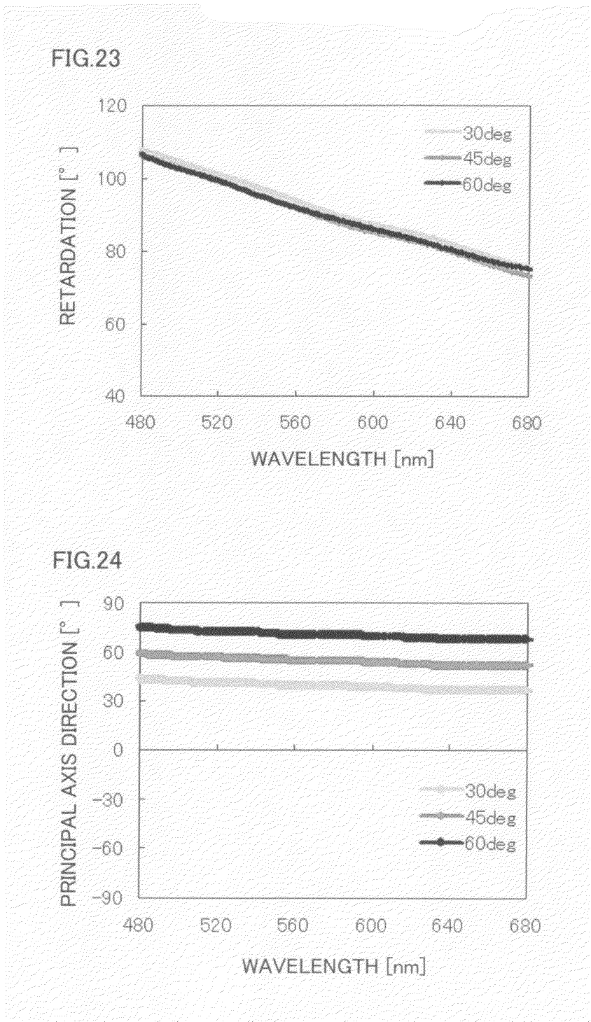

The data shown in FIG. 22 shows that the optical rotatory dispersion was almost the same even when the rotational angle of the composite component 50 changed. The data shown in FIG. 23 shows that the retardation was almost the same regardless of the rotational angle of the composite component 50. The data shown in FIG. 24 shows that the principal axis direction changed at almost the same interval.

The above results confirm the effectiveness of the optical characteristic measuring apparatus (optical characteristic measuring method) according to the invention regarding the simultaneous measurement of the optical rotatory dispersion, the birefringence dispersion, and the principal axis direction.

As described above, the measuring apparatus according to this embodiment can simultaneously measure the angle of rotation, the retardation, and the principal axis direction of the measurement sample 50 by snap-shot measurement without requiring mechanical/electrical operations. Therefore, the measuring method according to this embodiment can be applied in a wide variety of fields such as a liquid crystal display as a polymer material evaluation method.

### 3.7. This Embodiment is not Limited to the Above Configuration, and Various Modifications and Variations May be Made

For example, the optical characteristic measuring apparatus may be configured to measure the optical characteristics of a sample which reflects (does not transmit) light as the measurement sample 50. In this case, the optical system may be configured so that light emitted from the light source 12 is incident on the measurement sample 50 through the polarizer 22, the first carrier retarder 27, and the first quarter-wave plate 26, and the light reflected by the measurement sample 50 (light modulated by the measurement sample 50) is incident on the photodetector 42 through the second quarter-wave plate 36, the second carrier retarder 32, and the analyzer 34.

The above embodiment has been described taking an example in which the principal axis direction, the angle of rotation, and the retardation of the measurement sample 50 are measured in one shot. Note that the invention is not limited thereto. If necessary, only one or two of the principal axis direction, the angle of rotation, and the retardation may be measured.

### 4. Fourth Embodiment

An optical characteristic measuring apparatus according to a fourth embodiment to which the invention is applied is described below. The above description is applied to this embodiment as far as possible.

The optical characteristic measuring apparatus according to this embodiment is configured as a device which measures at least the dichroism of the measurement sample 50 as optical characteristics.

### 4.1. Optical Characteristic Measurement Device

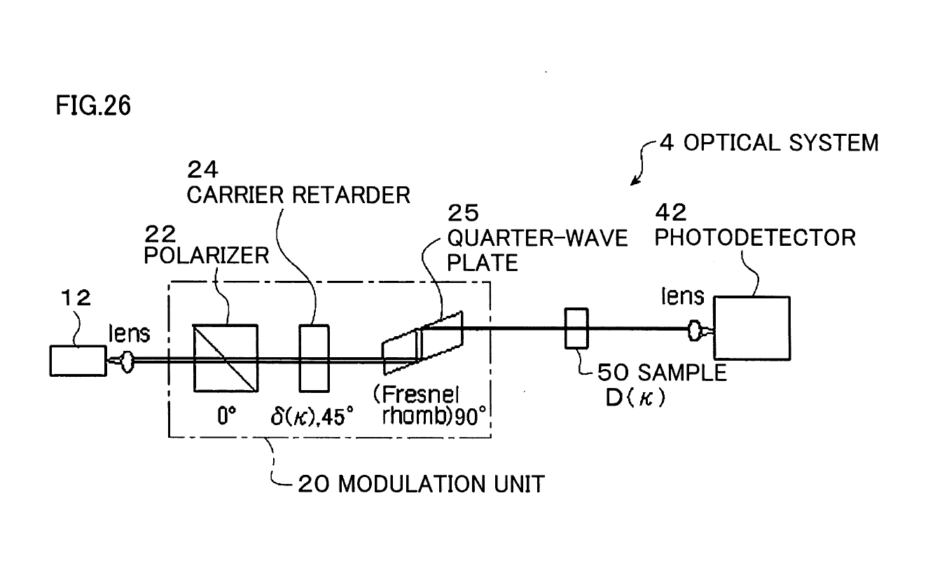

The configuration of the optical characteristic measuring apparatus according to the embodiment is described below. The optical characteristic measuring apparatus includes an optical system 4 shown in FIG. 26 and a calculation device (not shown).

The optical system 4 includes a polarizer 22, a carrier retarder 24, a quarter-wave plate 25, and a measurement sample 50 disposed in an optical path 100 connecting a light source 12 and a photodetector 42. The optical system 4 may have a configuration in which the analyzer 34 (analysis unit 30) is omitted from the above-described optical system 1. In this embodiment, light emitted from the measurement sample 50 is incident on the photodetector 42 without being modulated.

In the optical characteristic measuring apparatus according to this embodiment, the carrier retarder 24 may be set so that its principal axis direction differs from the principal axis direction of the polarizer 22 by 45° either clockwise or counterclockwise. The quarter-wave plate 25 may be set so that its principal axis direction differs from the principal axis direction of the carrier retarder 24 by 45° either clockwise or counterclockwise. The quarter-wave plate 25 may be set so that its principal axis direction differs from the principal axis direction of the polarizer 22 by 0° or 90° either clockwise or counterclockwise. This enables a highly accurate measurement. In the example shown in FIG. 26, the principal axis directions of the carrier retarder 24 and the quarter-wave plate 25 are rotated by 45° and 90°, respectively, with respect to the principal axis direction of the polarizer 22.

In this embodiment, the measurement sample 50 is a material (dichroic material) which exhibits dichroism as optical characteristics.

Light emitted from the light source 12 (light source) is modulated by the polarizer 22, the carrier retarder 24, and the quarter-wave plate 25 and then enters the measurement sample 50. The light is further modulated by the measurement sample 50 (while passing through the measurement sample 50 or being reflected by the measurement sample 50), and the resulting modulated light enters the photodetector 42.

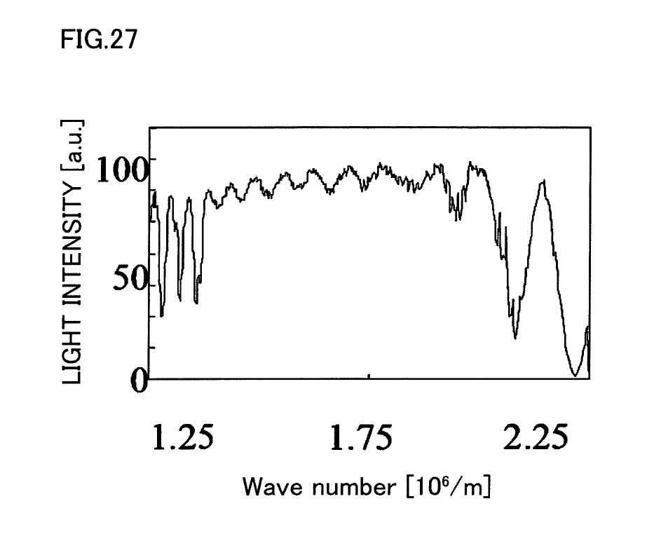

In the optical characteristic measuring apparatus according to the embodiment, a device which emits light (white light) containing a predetermined band component is used as the light source 12. Therefore, light emitted from the measurement sample 50 also contains the predetermined band component. A light intensity signal in wavelength units can be obtained by dispersing the light into a spectrum in wave number k units and measuring the light intensity in units of band components (wavelengths). FIG. 27 shows an example of the light intensity thus obtained.

### 4.2. Optical Characteristic Measurement Principle

The optical characteristic measurement principle employed in this embodiment is described below.

The Mueller matrices of the optical elements forming the optical system 4 are expressed as follows.

$$\begin{matrix}{P}_{0} = \frac{1}{2} [ \begin{matrix}1 & 1 & 0 & 0 \\ 1 & 1 & 0 & 0 \\ 0 & 0 & 0 & 0 \\ 0 & 0 & 0 & 0\end{matrix} ] & ( 28 ) \\ {R}_{45} = [ \begin{matrix}1 & 0 & 0 & 0 \\ 0 & cos δ ( k ) & 0 & - sin δ ( k ) \\ 0 & 0 & 0 & 0 \\ 0 & sin δ ( k ) & 0 & cos δ ( k )\end{matrix} ] & ( 29 ) \\ {Q}_{90} = [ \begin{matrix}1 & 0 & 0 & 0 \\ 0 & 1 & 0 & 0 \\ 0 & 0 & 0 & 1 \\ 0 & 0 & - 1 & 0\end{matrix} ] & ( 30 ) \\ {D}_{q ; r , θ} = [ \begin{matrix}q ( k ) + r ( k ) & ( q ( k ) - r ( k ) ) cos 2 θ & ( q ( k ) - r ( k ) ) sin 2 θ & 0 \\ ( q ( k ) - r ( k ) ) cos 2 θ & ( q ( k ) + r ( k ) ) {cos}^{2} 2 θ + 2 \sqrt{q ( k ) r ( k )} {sin}^{2} 2 θ & ( q ( k ) + r ( k ) - 2 \sqrt{qr} ) sin 2 θcos2θ & 0 \\ ( q ( k ) - r ( k ) ) sin 2 θ & ( q ( k ) + r ( k ) - 2 \sqrt{q ( k ) r ( k )} ) sin 2 θcos2 θ & ( q ( k ) + r ( k ) ) {sin}^{2} 2 θ + 2 \sqrt{q ( k ) r ( k )} {cos}^{2} 2 θ & 0 \\ 0 & 0 & 0 & 2 \sqrt{q ( k ) r ( k )}\end{matrix} ] & ( 31 )\end{matrix}$$

where, δ(k) indicates the retardation of the carrier retarder 24, and q(k) and r(k) respectively indicate the principle transmittances along the fast axis and the slow axis (f-axis and s-axis). θ indicates the direction of the fast axis.

When substituting the equations (28) to (31) in the following equation

Sₒᵤₜ=D_{q,r,θ}·Q₉₀·R₄₅·P₀·Sᵢₙ (32)

the light intensity I(k) detected by the optical system 4 (photodetector 42) is expressed as follows.

$$I ( k ) = \frac{1}{2} ( q ( k ) + r ( k ) + ( q ( k ) - r ( k ) ) cos [ δ ( k ) - 2 θ ] ) \qquad ( 33 )$$

Rewriting the equation (33) based on Euler's formula gives the following equation.

$$\begin{matrix}I ( k ) = a ( k ) + c ( k ) + {c}^{*} ( k ) \\ where , & ( 34 ) \\ a ( k ) = \frac{q ( k ) + r ( k )}{2} & ( 35 ) \\ c ( k ) = \frac{1}{2} ( q ( k ) - r ( k ) ) exp ( i δ ( k ) - 2 θ ) & ( 36 )\end{matrix}$$

The equation (34) is expressed as follows by subjecting the light intensity to Fourier transformation (analysis process in a broad sense) with respect to the wave number k.

Ī(v)=A(v)+C(v)+C*(v) (37)

where, A(v) and C(v) respectively indicate the Fourier spectra of a(k) and c(k), and C*(v) indicates the conjugate component of C(v). The Fourier spectra A(v) and C(v) respectively contain a q(k)+r(k) component and a q(k)−r(k) component showing dichroism and θ indicating the directions (see the equations (35) and (36)). Therefore, extracting each Fourier spectrum and subjecting the Fourier spectrum to an analysis process (Fourier transformation) yield the following equations.

$$\begin{matrix}{F}^{- 1} [ A ( v ) ] = a ( k ) = \frac{q ( k ) + r ( k )}{2} & ( 38 ) \\ {F}^{- 1} [ C ( v ) ] = c ( k ) = \frac{1}{2} ( q ( k ) - r ( k ) ) exp ( i δ ( k ) - 2 θ ) & ( 39 )\end{matrix}$$

q(k)−r(k) and θ in the equation (39) are expressed as follows using a real number component Re[c(k)] and an imaginary number component Im[c(k)] of c(k).

$$\begin{matrix}q ( k ) - r ( k ) = 2 \sqrt{{Re [ c ( k ) ]}^{2} + {Im [ c ( k ) ]}^{2}} & ( 40 ) \\ θ = \frac{1}{2} {tan}^{- 1} \frac{Re [ c ( k ) ]}{Im [ c ( k ) ]} & ( 41 )\end{matrix}$$

The dichroism dispersion D(k) is expressed as follows.

$$D ( k ) = \frac{q ( k ) - r ( k )}{q ( k ) + r ( k )} \qquad ( 42 )$$

### 4.3. Utilization of Measured Values

The values F¹[A(v)] and F¹[C(v)] in the equations (38) and (39) can be calculated from measured values. Specifically, the values F¹[A(v)] and F¹[C(v)] can be calculated by subjecting the light intensity I(k) detected by the photodetector 42 to Fourier transformation (analysis process in a broad sense) with respect to the wave number k to obtain a Fourier spectrum, extracting the spectral peaks from the Fourier spectrum, and subjecting the spectral peaks to Fourier analysis.

The value a(k) and the real number component Re[c(k)] and the imaginary number component Im[c(k)] of c(k) can be derived utilizing the values F⁻¹[A(v)] and F⁻¹[C(v)] thus calculated.

The dichroism dispersion D(k) of the measurement target 50 can be calculated based on the values a(k), Re[c(k)], and Im[c(k)] and the equations (38) to (40) and (42).

### 4.4. Optical Characteristic Measurement Process

An optical characteristic measurement process employed for the optical characteristic measuring apparatus according to the embodiment is described below.

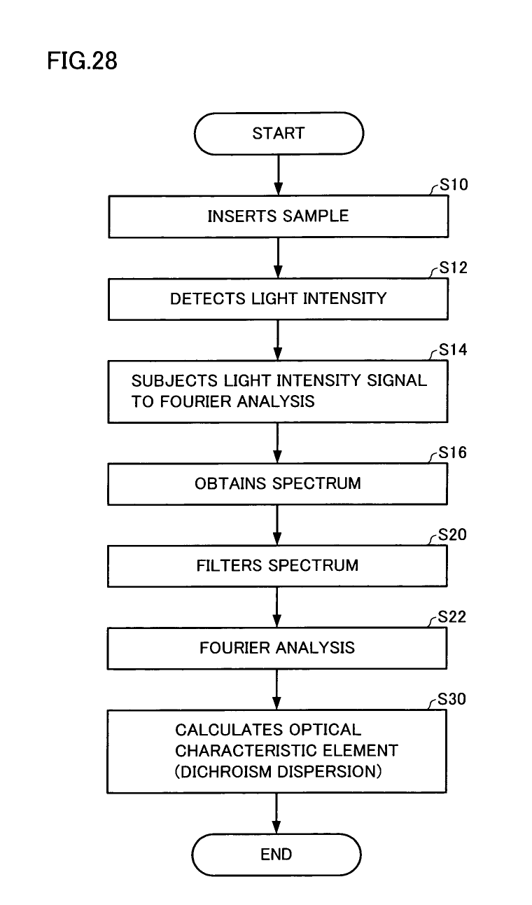

FIG. 28 is a flowchart showing the optical characteristic measurement process.

The measurement sample 50 is disposed in the optical path of the optical system 4 (step S10).

Light is emitted from the light source 12 and modulated by the optical elements of the optical system 4 and the measurement sample 50. The modulated light is received by the photodetector 42 to detect the light intensity (step S12).

The light intensity signal is then subjected to Fourier transformation (inverse Fourier transformation) with respect to the wave number k (step S14) to obtain a spectrum (Fourier spectrum or frequency spectrum) (step S16). The Fourier spectrum thus obtained includes the spectral peaks A(v) and C(v).

The spectrum is then filtered (step S20). This allows the spectral peaks A(v) and C(v) to be extracted from the Fourier spectrum. This step may be performed by filtering.

In the subsequent step S22, the spectral peaks A(v) and C(v) are subjected to Fourier analysis (e.g. FFT).

As described above, each value of the spectral peaks is calculated as the measured value in the steps S12 to S22 from the light intensity signal of the measurement light obtained by the photodetector 42.

An optical characteristic element calculation process for calculating the dichroism of the measurement sample 50 is performed in a step S30. Specifically, each value of the equations (38) and (40) is calculated, and the dichroism dispersion D(k) (optical characteristic element in a broad sense) shown by the equation (42) is calculated based on the calculated values.

### 4.4. Verification Experiment

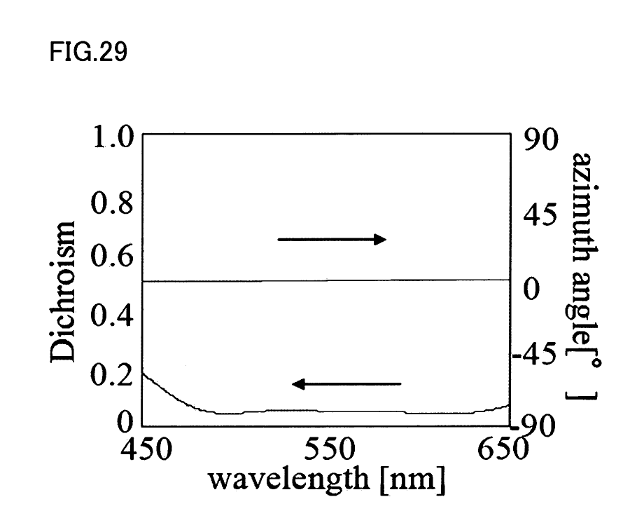

A verification experiment for confirming the effectiveness of the measuring apparatus according to this embodiment was conducted. FIG. 29 shows the results of the verification experiment. In the verification experiment, a partially polarized film was used as the measurement sample.

As shown in FIG. 29, it was confirmed that the principal axis direction showed a constant value with respect to the wavelength. It was also confirmed that the dichroism dispersion was about 0.05 at a wavelength of about 500 nm to 650 nm and increased at a wavelength of about 450 nm.

### 5. Modification

The invention is not limited to the above embodiments. Various modifications and variations may be made. For example, the invention includes configurations substantially the same as the configurations described in the embodiments (in function, in method and effect, or in objective and effect). The invention also includes configurations in which an unsubstantial portion described in the embodiments is replaced. The invention also includes configurations having the same effects as the configurations described in the embodiments, or configurations capable of achieving the same objective. Further, the invention includes configurations in which a known technique is added to the configurations described in the embodiments.

For example, the optical characteristic measuring apparatuses using a white light source as the light source (light source 12) have been described in the first to fourth embodiments. Note that the invention is not limited thereto. In the invention, a frequency spectrum is obtained by analyzing the light intensity signal detected by the light-receiving means. Therefore, the invention requires obtaining a light intensity signal from which a frequency spectrum can be obtained by analysis. In other words, the optical characteristic measuring apparatus according to the invention may be applied to any device (optical system) which can obtain a frequency spectrum by analysis.

Therefore, the optical characteristic measuring apparatus according to the embodiments of the invention may be configured so that the light source sequentially emits first light to Mth light (M is an integer equal to or larger than two) which differ in band (differ in wavelength). Data indicating the light intensity (light intensity distribution) for a predetermined band component represented by FIG. 6 or 27 can be obtained by associating the light intensity detected by the light-receiving means with the band (wavelength) of emitted light (or light incident on the light-receiving means).

The optical characteristic element of the measurement sample 50 can be calculated by analyzing the data (light intensity signal or light intensity information) with respect to the wave number k, extracting the spectral peak from the frequency spectrum thus obtained, and performing the optical characteristic element calculation process.

In this modification, the operation of the light source (e.g. emission timing and wavelength of emitted light) may be controlled by the calculation device 60. Specifically, the light source may be configured to sequentially change the wavelength of emitted light based on a control signal from the calculation device 60. The calculation device 60 may be configured to generate data indicating the light intensity (light intensity distribution data) while associating the light intensity with the wavelength of emitted light.

In this modification, the optical system may include a spectroscopic means which disperses light containing a predetermined band component into a spectrum before the light is incident on the first polarizer.

The optical characteristics can also be accurately measured in a short period of time by employing the above configuration. An optical characteristic measuring apparatus in which optical elements forming an optical system need not be mechanical or electrically driven can also be provided by employing the above configuration. Specifically, the above configuration also allows provision of a high-performance optical characteristic measuring apparatus with a simple configuration as compared with a related-art device and a measuring method for implementing the optical characteristic measuring apparatus.

The optical activity measurement using the invention can be utilized for management of the sugar concentration of food, drinking water, and the like, examination and evaluation of medical products, and research and development of new materials.

The optical activity measurement using the invention can be utilized for evaluation of organic polymer materials such as a liquid crystal and research and development of new materials, and can also be applied to quality control of a polymer orientation state and the like. A finding obtained therefrom is very effective for development of new materials.

Moreover, it becomes possible to inspect inorganic materials such as semiconductors and optical crystals and measure the photoelastic constant and the stress distribution occurring in the materials. Therefore, it is possible to determine the state of stress applied to optical elements by monitoring the measured values in real time. Since the invention enables snap-shot measurement, the dispersion characteristics of a fast phenomenon can be detected.

The invention can also be applied to the field of biotechnology in addition to the above organic and inorganic polymer materials.

1. An optical characteristic measuring apparatus measuring optical characteristics of a measurement target, the optical characteristic measuring apparatus comprising:
an optical system including first and second carrier retarders of which the retardations are known and differ from each other and first and second quarter-wave plates without wavelength dependence, the optical system causing light emitted from a light source to be incident on the measurement target through a first polarizer, the first carrier retarder, and the first quarter-wave plate and modulated by the measurement target, and causing the modulated light to be incident on light-receiving means through the second quarter-wave plate, the second carrier retarder, and a second polarizer; and
calculation means for performing a spectrum extraction process of extracting a spectral peak from a frequency spectrum obtained by analyzing a light intensity signal detected by the light-receiving means, and an optical characteristic element calculation process of calculating an optical characteristic element representing the optical characteristics of the measurement target based on the extracted spectral peak and the retardations of the first and second carrier retarders.

2. The optical characteristic measuring apparatus as defined in claim 1,
wherein the optical system is set so that:
the principal axis direction of the first carrier retarder is rotated by 45° either clockwise or counterclockwise with respect to the principal axis direction of the first polarizer;
the principal axis direction of the first quarter-wave plate is rotated by 45° either clockwise or counterclockwise with respect to the principal axis direction of the first carrier retarder; and
the principal axis direction of the first quarter-wave plate is rotated by 0° or 90° either clockwise or counterclockwise with respect to the principal axis direction of the first polarizer.

3. The optical characteristic measuring apparatus as defined in claim 1,
wherein the optical system is set so that:
the principal axis direction of the second carrier retarder is rotated by 45° either clockwise or counterclockwise with respect to the principal axis direction of the second polarizer;
the principal axis direction of the second quarter-wave plate is rotated by 45° either clockwise or counterclockwise with respect to the principal axis direction of the second carrier retarder; and
the principal axis direction of the second quarter-wave plate is rotated by 0° or 90° either clockwise or counterclockwise with respect to the principal axis direction of the second polarizer.

4. The optical characteristic measuring apparatus as defined in claim 1,
wherein, when the retardations of the first and second carrier retarders are αδ and βδ, the retardations of the first and second carrier retarders are set so that a ratio of (α+β) and (α−β) is two or more or ½ or less.

5. The optical characteristic measuring apparatus as defined in claim 1,
wherein the calculation means calculates at least one of the angle of rotation, the retardation, and the principal axis direction of the measurement target.

6. The optical characteristic measuring apparatus as defined in claim 1,
wherein the calculation means subjects the spectral peak extracted by the spectrum extraction process to Fourier analysis to calculate a real number component and an imaginary number component of the spectral peak, and calculates the optical characteristic element of the measurement target based on the real number component and the imaginary number component of the spectral peak and the retardations of the first and second carrier retarders.

7. An optical characteristic measuring apparatus measuring optical characteristics of a measurement target, the optical characteristic measuring apparatus comprising:
an optical system including a carrier retarder of which the retardation is known and a quarter-wave plate without wavelength dependence, the optical system causing light emitted from a light source to be incident on the measurement target through a first polarizer, the carrier retarder, and the quarter-wave plate and modulated by the measurement target, and causing the modulated light to be incident on light-receiving means through a second polarizer; and
calculation means performing a spectrum extraction process of extracting a spectral peak from a frequency spectrum obtained by analyzing a light intensity signal detected by the light-receiving means, and an optical characteristic element calculation process of calculating an optical characteristic element representing the optical characteristics of the measurement target based on the extracted spectral peak and the retardation of the carrier retarder.

8. The optical characteristic measuring apparatus as defined in claim 7,
wherein the optical system is set so that:
the principal axis direction of the carrier retarder is rotated by 45° either clockwise or counterclockwise with respect to the principal axis direction of the first polarizer;
the principal axis direction of the quarter-wave plate is rotated by 45° either clockwise or counterclockwise with respect to the principal axis direction of the carrier retarder; and
the principal axis direction of the quarter-wave plate is rotated by 0° or 90° either clockwise or counterclockwise with respect to the principal axis direction of the first polarizer.

9. The optical characteristic measuring apparatus as defined in claim 7,
wherein the calculation means calculates at least the angle of rotation of the measurement target.

10. An optical characteristic measuring apparatus measuring optical characteristics of a measurement target, the optical characteristic measuring apparatus comprising:
an optical system including a carrier retarder of which the retardation is known and a quarter-wave plate without wavelength dependence, the optical system causing light emitted from a light source to be incident on the measurement target through a first polarizer and modulated by the measurement target, and causing the modulated light to be incident on light-receiving means through the quarter-wave plate, the carrier retarder, and a second polarizer; and
calculation means performing a spectrum extraction process of extracting a spectral peak from a frequency spectrum obtained by analyzing a light intensity signal detected by the light-receiving means, and an optical characteristic element calculation process of calculating an optical characteristic element representing the optical characteristics of the measurement target based on the extracted spectral peak and the retardation of the carrier retarder.

11. The optical characteristic measuring apparatus as defined in claim 10,
wherein the optical system is set so that:
the principal axis direction of the carrier retarder is rotated by 45° either clockwise or counterclockwise with respect to the principal axis direction of the second polarizer;
the principal axis direction of the quarter-wave plate is rotated by 45° either clockwise or counterclockwise with respect to the principal axis direction of the carrier retarder; and
the principal axis direction of the quarter-wave plate is rotated by 0° or 90° either clockwise or counterclockwise with respect to the principal axis direction of the second polarizer.

12. The optical characteristic measuring apparatus as defined in claim 10,
wherein the calculation means calculates at least the angle of rotation of the measurement target.

13. An optical characteristic measuring apparatus measuring optical characteristics of a measurement target, the optical characteristic measuring apparatus comprising:
an optical system including a carrier retarder of which the retardation is known and a quarter-wave plate without wavelength dependence, the optical system causing light emitted from a light source to be incident on the measurement target through a polarizer, the carrier retarder, and the quarter-wave plate and modulated by the measurement target, and causing the modulated light to be incident on light-receiving means; and
calculation means performing a spectrum extraction process of extracting a spectral peak from a frequency spectrum obtained by analyzing a light intensity signal detected by the light-receiving means, and an optical characteristic element calculation process of calculating an optical characteristic element representing the optical characteristics of the measurement target based on the extracted spectral peak and the retardation of the carrier retarder.

14. The optical characteristic measuring apparatus as defined in claim 13,
wherein the optical system is set so that:
the principal axis direction of the carrier retarder is rotated by 45° either clockwise or counterclockwise with respect to the principal axis direction of the polarizer;
the principal axis direction of the quarter-wave plate is rotated by 45° either clockwise or counterclockwise with respect to the principal axis direction of the carrier retarder; and
the principal axis direction of the quarter-wave plate is rotated by 0° or 90° either clockwise or counterclockwise with respect to the principal axis direction of the polarizer.

15. The optical characteristic measuring apparatus as defined in claim 13,
wherein the calculation means calculates at least the dichroism of the measurement target.

16. The optical characteristic measuring apparatus as defined in claim 7,
wherein the calculation means subjects the spectral peak extracted by the spectrum extraction process to Fourier analysis to calculate a real number component and an imaginary number component of the spectral peak, and calculates the optical characteristic element of the measurement target based on the real number component and the imaginary number component of the spectral peak and the retardation of the carrier retarder.

17. The optical characteristic measuring apparatus as defined in claim 1,
wherein the light source emits light containing a predetermined band component; and
wherein the optical system further includes spectroscopic means which disperses the light containing the predetermined band component into a spectrum and causes the light dispersed into a spectrum to be incident on the light-receiving means.

18. The optical characteristic measuring apparatus as defined in claim 1,
wherein the light source sequentially emits first light to Mth light (M is an integer equal to or larger than two) which differ in band.

19. The optical characteristic measuring apparatus as defined in claim 1,
wherein the light-receiving means includes two-dimensionally arranged light-receiving sections;
wherein the optical system includes a light guide causing the light to be incident on the two-dimensionally arranged light-receiving sections of the light-receiving means; and
wherein the calculation means calculates the optical characteristics of the measurement target by performing the spectrum extraction process and the optical characteristic calculation process in units of the light-receiving sections of the light-receiving means.

20. An optical characteristic measuring method for measuring optical characteristics of a measurement target, the optical characteristic measuring method comprising:
a process of providing first and second carrier retarders of which the retardations are known and differ from each other and first and second quarter-wave plates without wavelength dependence, causing light emitted from a light source to be incident on the measurement target through a first polarizer, the first carrier retarder, and the first quarter-wave plate and modulated by the measurement target, and causing the modulated light to be incident on light-receiving means through the second quarter-wave plate, the second carrier retarder, and a second polarizer;
a spectrum extraction process of extracting a spectral peak from a frequency spectrum obtained by analyzing a light intensity signal detected by the light-receiving means; and
an optical characteristic element calculation process of calculating an optical characteristic element representing the optical characteristics of the measurement target based on the extracted spectral peak and the retardations of the first and second carrier retarders.

21. An optical characteristic measuring method for measuring optical characteristics of a measurement target, the optical characteristic measuring method comprising:
a process of providing a carrier retarder of which the retardation is known and a quarter-wave plate without wavelength dependence, causing light emitted from a light source to be incident on the measurement target through a first polarizer, the carrier retarder, and the quarter-wave plate and modulated by the measurement target, and causing the modulated light to be incident on light-receiving means through a second polarizer;
a spectrum extraction process of extracting a spectral peak from a frequency spectrum obtained by analyzing a light intensity signal detected by the light-receiving means; and
an optical characteristic element calculation process of calculating an optical characteristic element representing the optical characteristics of the measurement target based on the extracted spectral peak and the retardation of the carrier retarder.

22. An optical characteristic measuring method for measuring optical characteristics of a measurement target, the optical characteristic measuring method comprising:
a process of providing a carrier retarder of which the retardation is known and a quarter-wave plate without wavelength dependence, causing light emitted from a light source to be incident on the measurement target through a first polarizer and modulated by the measurement target, and causing the modulated light to be incident on light-receiving means through the quarter-wave plate, the carrier retarder, and a second polarizer;
a spectrum extraction process of extracting a spectral peak from a frequency spectrum obtained by analyzing a light intensity signal detected by the light-receiving means; and
an optical characteristic element calculation process of calculating an optical characteristic element representing the optical characteristics of the measurement target based on the extracted spectral peak and the retardation of the carrier retarder.

23. An optical characteristic measuring method for measuring optical characteristics of a measurement target, the optical characteristic measuring method comprising:
a process of providing a carrier retarder of which the retardation is known and a quarter-wave plate without wavelength dependence, causing light emitted from a light source to be incident on the measurement target through a polarizer, the carrier retarder, and the quarter-wave plate and modulated by the measurement target, and causing the modulated light to be incident on light-receiving means;
a spectrum extraction process of extracting a spectral peak from a frequency spectrum obtained by analyzing a light intensity signal detected by the light-receiving means; and
an optical characteristic element calculation process of calculating an optical characteristic element representing the optical characteristics of the measurement target based on the extracted spectral peak and the retardation of the carrier retarder.

24. The optical characteristic measuring method as defined in claim 20,
wherein the light source emits light containing a predetermined band component; and
wherein the light modulation process includes dispersing the light containing the predetermined band component into a spectrum and causing the light dispersed into a spectrum to be incident on the light-receiving means.

25. The optical characteristic measuring method as defined in claim 20,
wherein the light source sequentially emits first light to Mth light (M is an integer equal to or larger than two) which differ in band.
